(19) United States
(12) Patent Application Publication
(10) Pub. No.: US 2026/0109111 A1
(43) Pub. Date: Apr. 23, 2026

(54) VOLUMETRIC PRINTING OF MULTI-SCALE AND MULTI-MATERIAL STRUCTURES VIA LIGHT INITIATED DIRECT GROWTH

(71) Applicant: Xiangjia Li, Chandler, AZ (US)

(72) Inventor: Xiangjia Li, Chandler, AZ (US)

(21) Appl. No.: 19/326,505

(22) Filed: Sep. 11, 2025

Related U.S. Application Data
(60) Provisional application No. 63/694,566, filed on Sep. 13, 2024.

(51) Int. Cl. B29C 64/255; B29C 64/135

(52) U.S. Cl. CPC B29C 64/255; B29C 64/135

(57) ABSTRACT

A method of forming a part within a resin tank of a 3D printer includes curing a bottom surface of the part within a first section of the resin tank via a focused curing light while exposing a remainder of the resin tank to an inhibition light, curing a middle section of the part within a second section of the resin tank via the curing light while exposing areas above and below the second section to the inhibition light, and curing a top surface of the part within a third section of the resin tank via the curing light while exposing the remainder of the resin tank to the inhibition light.

### CROSS-REFERENCE TO RELATED APPLICATIONS

This application claims priority to U.S. Provisional Application No. 63/694,566 filed 13 Sep. 2024, the entire contents of which are incorporated herein by reference.

### FIELD OF THE INVENTION

The present invention relates to additive manufacturing (AM) processes, such as vat photopolymerization (VPP), that create 3D objects by selectively curing liquid resin through targeted light-activated polymerization.

### SUMMARY

The technology relates to a novel 3D-printing method called light-initiated direct growth (LIDG). Conventional layer-by-layer additive manufacturing methods used to create 3D printed materials are highly dependent on the printing orientation and lead to undesired anisotropic properties and performance of the materials. A novel volumetric printing process, LIDG, overcomes these drawbacks. LIDG features constructing desired geometries by direct manipulation of light inside the resin tank. Light is projected from either the bottom or top of the tank, and the focusing layer is shifted along with the growth of the part. The profile shape of the printed part is modulated by controlling the projection pattern and light intensity. A multi-wavelength curing system is designed as a tool to dynamically cure 3D objects with different material distributions. The mechanical properties of the printed objects are manipulated by adjusting the light intensity and printing speed. A calibration algorithm of light accumulation and attenuation is introduced to create accurate light energy distribution for the fabrication of 3D objects inside the resin tank. The LIDG method is able to create objects with micro and mesoscale structures, with multi-material and multi-functions, and that do not require extra support and at ultra-fast speeds.

In some aspects, the techniques described herein relate to a method of forming a part within a resin tank of a 3D printer, the method including: curing a bottom surface of the part within a first section of the resin tank via a focused curing light while exposing a remainder of the resin tank to an inhibition light; curing a middle section of the part within a second section of the resin tank via the curing light while exposing areas above and below the second section to the inhibition light; and curing a top surface of the part within a third section of the resin tank via the curing light while exposing the remainder of the resin tank to the inhibition light.

In some aspects, the techniques described herein relate to a method, wherein the first section of the resin tank is a bottom section of the resin tank.

In some aspects, the techniques described herein relate to a method, wherein the curing light is shown through a bottom of the resin tank.

In some aspects, the techniques described herein relate to a method, wherein the inhibition light is shown through a sidewall of the resin tank.

In some aspects, the techniques described herein relate to a method, wherein the curing light is shown through a top of the resin tank.

In some aspects, the techniques described herein relate to a method, wherein the curing light is shown through a top and a bottom of the resin tank.

In some aspects, the techniques described herein relate to a method, wherein curing the bottom surface, the middle section, and the top surface of the part includes photopolymerization.

In some aspects, the techniques described herein relate to a method, wherein curing the bottom surface, curing the middle section, and curing the top surface are completed in order and continuously such that no layer or stair-case effect is in the part once the top surface is cured.

In some aspects, the techniques described herein relate to a method, wherein the resin tank is not refilled during the forming of the part.

In some aspects, the techniques described herein relate to a method, wherein the bottom surface, the middle section, and the top surface are cured via a curing light from a projector, wherein the curing light from the projector passes through a convex lens prior to curing the bottom surface, the middle section, and the top surface.

In some aspects, the techniques described herein relate to a method, wherein the resin tank is movable relative to the projector as the bottom surface, the middle section, and the top surface are cured.

In some aspects, the techniques described herein relate to a method, wherein the resin tank is supported by a linear stage, wherein the linear stage moves the resin tank relative to the projector.

In some aspects, the techniques described herein relate to a method, wherein the resin tank moves continuously during the forming of the part.

In some aspects, the techniques described herein relate to a method, wherein the inhibition light is generated by an inhibition projector separate from the projector providing the curing light.

In some aspects, the techniques described herein relate to a method, wherein the inhibition projector is supported by the linear stage and movable with the resin tank.

In some aspects, the techniques described herein relate to an apparatus for forming a part within a resin tank of a 3D printer, the apparatus including: a resin tank having a bottom surface and a sidewall and configured to hold a resin material; a projector configured to focus a curing light through the bottom surface of the resin tank to cure a first portion of the resin material; and an inhibition projector configured to focus an inhibition light through the sidewall of the resin tank to inhibit curing of a second portion of the resin material.

In some aspects, the techniques described herein relate to an apparatus, wherein the projector is configured to cure the first portion of the resin material via continuous photopolymerization such that no layer or stair-case effect is in the part.

In some aspects, the techniques described herein relate to an apparatus, further including a convex lens, wherein the curing light from the projector passes through the convex lens prior to curing the first portion of the resin material.

In some aspects, the techniques described herein relate to an apparatus, further including a linear stage coupled to the resin tank and configured to move the resin tank relative to the projector during formation of the part.

In some aspects, the techniques described herein relate to an apparatus, wherein the inhibition projector is supported by the linear stage and movable with the resin tank relative to the projector.

Other aspects of the invention become apparent by consideration of the detailed description and accompanying drawings.

### BRIEF DESCRIPTION OF THE DRAWINGS

FIG. 1a illustrates a prototype of an LIDG process.

FIG. 1b illustrates an optical module and light path.

FIG. 2 illustrates curing characteristics at different grayscale levels.

FIG. 3a is a schematic of a first printing strategy having no focusing adjustment.

FIG. 3b is a schematic of a second printing strategy having a focusing adjustment.

FIG. 4a illustrates part growth under a macro-scale projection.

FIG. 4b illustrates part growth under a micro-scale projection.

FIG. 4c illustrates cured height at different times under macro- and micro-scale projections.

FIG. 5 illustrates Gaussian function models of light intensity distribution of single pixels of different gray scale levels.

FIG. 6a illustrates a position of refraction.

FIG. 6b is a schematic of a refractive index measurement.

FIG. 7 is a schematic of light intensity measurements under various conditions.

FIG. 8a illustrates a simulation of optical energy distribution in an XZ plate under macroscale exposure.

FIG. 8b illustrates a simulation of optical energy distribution in an XZ plate under microscale exposure.

FIG. 9a illustrates an average curing speed under various gray scales.

FIG. 9b illustrate curing height curves of various gray scale exposures.

FIG. 10a illustrates a growth curve of resin with different dye concentrations.

FIG. 10b illustrates curing characteristics for resin with different dye concentrations in a logarithmic coordinate.

FIG. 10c illustrates a relationship fitting between characteristic penetration depth and dye concentration.

FIG. 10d illustrates a relationship fitting between max curing height and dye concentration.

FIG. 11a illustrates micro-scale fabrication results, Designed CAD model, printing results and side view microscope image and demo test of a transparent lens array.

FIG. 11b illustrate micro-scale fabrication results, Hierarchical surface structure of springtails (Collembola), CAD model of biomimetic structure, microscope image of fabrication results, and contact angle test results.

FIG. 11c illustrates micro-scale fabrication results, Triangle array surface structure of daisy, CAD model of biomimetic structure, microscope image of fabrication results and contact angle test results.

FIG. 12a illustrates a growth curve under various gray scale exposures.

FIG. 12b illustrates fabrication speed and resolution of different types of VPP methods.

FIG. 13a illustrates an LIDG printed tower.

FIG. 13b illustrates a dye droplet in resin without movement or exposure at 0 s and at 120 s.

FIG. 13c illustrates a dye droplet in resin with movement but no exposure at 0 s and 20 s.

FIG. 13d illustrates a dye droplet in resin with exposure but no movement at 0 s, 10 s and 20 s.

FIG. 14a illustrates rheological behaviors of resin made with different weight ratio between BPAGDA and PEGDA.

FIG. 14b illustrates static viscosity of resins made with different weight ratio between BPAGDA and PEGDA and critical viscosity.

FIG. 14c illustrates structures printed with low viscosity resin (static viscosity=0.35 Pa·s).

FIG. 14d illustrates structures printed with high viscosity resin (static viscosity=6.97 Pa·s).

FIG. 15a illustrates a CAD model and fabrication results of a logo.

FIG. 15b illustrates a CAD model and fabrication results of a QR code.

FIG. 15c illustrates a CAD model and fabrication results of a tower.

FIG. 15d illustrates coordinates within an optical field.

FIG. 16 illustrates a mask image optimization to generate an appropriate optical field energy distribution to achieve volumetric printing.

FIG. 17a illustrates setup of an LIDG process with inhibition light.

FIG. 17b is a schematic illustration of an LIDG printing process with inhibition light.

FIG. 17c illustrates a material molecular in resin formulation.

FIG. 17d illustrates a printing process.

FIG. 18a is a schematic illustration of photopolymerization and photo-inhibition.

FIG. 18b is a schematic illustration of the printing capability of LIDG printing process with inhibition light.

FIG. 18c illustrates molecular absorbance spectrum of photo-initiator CQ and photo-inhibitor o-CI-HABI.

FIG. 18d illustrates a working range for photo-inhibitor and photo-initiator concentrations (the ratio between CQ and EDAB remaining the same).

FIG. 19a illustrates curing curves of different gray scale levels with and without inhibition light.

FIG. 19b illustrates an average curing speed of different gray scale levels with and without inhibition light.

FIG. 20 illustrates different printing stages of various printing processes.

FIG. 21a illustrates a CAD model of a gear and rack demo printing.

FIG. 21b illustrates mask images and inhibition images of the gear and rack demo printing.

FIG. 21c illustrates a printed part of the gear and rack demo printing.

FIG. 21d illustrates a CAD model of a logo.

FIG. 21e illustrates mask images and inhibition images of the logo.

FIG. 21f illustrates a printed part of the logo.

FIG. 22 illustrate an optical module of a multi-material setup.

FIG. 23a illustrates epoxy formulation and absorbance spectrum of photosensitizer H-Nu 470.

FIG. 23b illustrates acrylate formulation and absorbance spectrum of photo-initiators Omnirad 2100.

FIG. 23c is a schematic illustration of the thiol-acrylate photo-resin.

FIG. 23d illustrates UV-Vis absorption spectra of Eosin Y and TBD-HBPh4.

FIG. 23e illustrates UV-Vis absorption spectra of Omnirad 2100.

FIG. 23f illustrates UV-Vis absorption spectra of a photo-resin mixture.

FIG. 24a illustrates printing speed of various materials under various gray scale levels.

FIG. 24b illustrates Young's modulus of cured Acrylic and Epoxy.

FIG. 24c illustrates printed dog bones for tensile tests.

FIG. 25a illustrates a demo printing of a butterfly with a UV light mask image.

FIG. 25b illustrates a demo printing of the butterfly with green light exposure.

FIG. 25c illustrates a demo printing of the butterfly in the curing process.

FIG. 25d illustrates a demo printing of the butterfly as a post-treated part.

FIG. 25e illustrates a demo printing of a logo with a UV light mask image.

FIG. 25f illustrates a demo printing of the logo with green light exposure.

FIG. 25g illustrates a demo printing of the logo in the curing process.

FIG. 25h illustrates a demo printing of the logo as a post-treated part.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

The methods and systems described herein develop a novel volumetric vat photopolymerization (VPP) printing method that is capable of multi-scale, multi-material and rapid fabrication. Light energy initiates photopolymerization at the outer surface of a solidified portion and polymerized resin grows around the outer surface (in most circumstances the upper surface). Eventually a part with a desired complex 3D geometry features grows fully inside the translucent photocurable liquid polymer. A novel VPP method, named as Light Initiated Direct Growth (LIDG), can be accomplished in a manner that a designed structure directly grows in a vat filled with liquid polymer under the exposure of a projection light from the bottom of the vat. Based on this inspiration, a series of studies are conducted to realize this printing method and explore the capabilities of this approach.

Accomplishing the LIDG process utilizes photopolymerization. The chemical reaction of photopolymerization makes it possible to cure structure directly inside the vat by controlling the energy distribution dose in 3D space. On the other hand, all resin kept in ambient air has oxygen dissolved which inhibits the free radical photopolymerization. The actual curing only starts when the energy distribution doses at a certain position reach a threshold where the free radical generation speed is comparable to the speed of reaction between oxygen molecules and free radicals. Therefore, in the combination with other inhibitors dissolved in the resin, oxygen guarantees that the photopolymerization only happens at positions where the energy distribution reaches the threshold for curing, as transparent resin is incorporated in this project and the light penetrates the cured section, curing section and reaches a further position. With the inhibition of oxygen, only the exposure intensity for this process is adjusted to make sure that the penetrated optical energy is lower than the curing threshold.

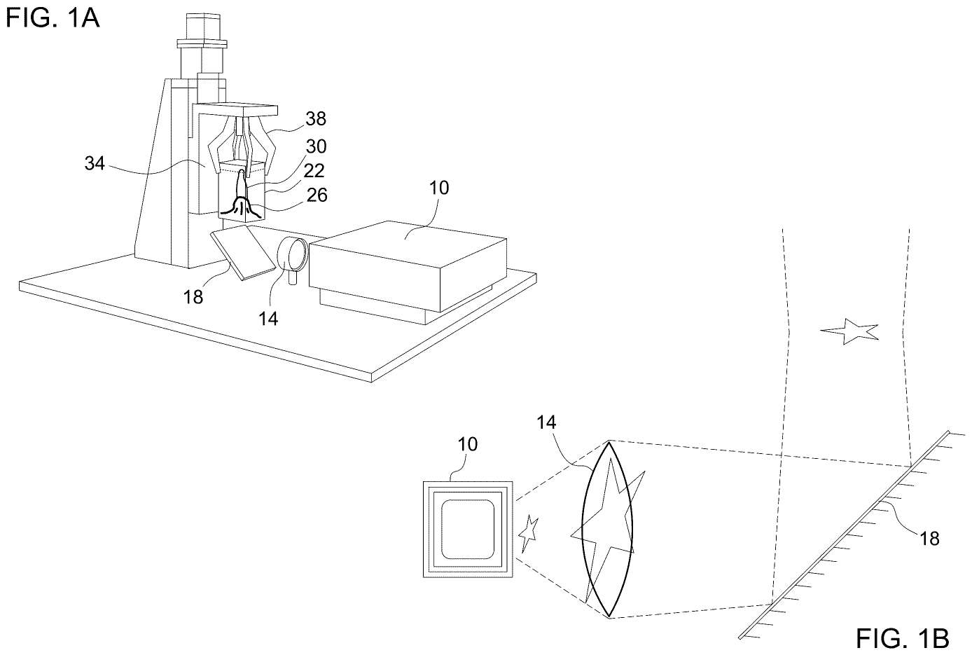

Then, to test the possibility of the proposed LIDG process and explore further capabilities, a hardware setup is built (as shown in FIG. 1a). A DLP projector 10 is utilized as the light source to initiate the polymerization process and control the 2D pattern of light exposure. A convex lens 14 is applied to change the diverging light into concentrated light and a mirror 18 is used to change the direction of optical path. A vat 22 filled with transparent resin is mounted on a linear stage 34 and moves up and down to adjust the relative focus position in the resin vat 22. In the illustrated embodiment, a holding mechanism 38 holds the vat 22 on the linear stage 34. During the printing process, the projection light penetrates the photopolymerized section 26 and distribute enough optical energy onto the layer 30 above the cured section 26 to initiate the curing. To clarify, the layer 30 in the LIDG process only refers to the position of a thin slice of resin and since the printing process is conducted continuously, there is no layer or stair-case effect in the final fabricated part. The whole fabrication process happens on top of the vat bottom and the part grows individually without any contact with other objects. Thus, no separation or liquid refilling exists in the whole process which limits the fabrication speed of layer based and continuous VPP process.

Optical module is an important factor determining the success of the LIDG process. Typically, a usual commercial DLP projector has a long focus distance and large image size with limited optical energy concentration. Long focus distance results in unnecessary large setup and limited optical energy concentration leads to slow photopolymerization speed and short penetration depth. Therefore, a convex lens 14 is used to concentrate the optical energy and adjust the focus distance to a reasonable range. Additionally, the process demands a light shot from bottom, so a 45-degree mirror 18 is incorporated to reflect horizontally shooting light into vertically shooting light. Then, an optical module is designed and built based on the parameters (as shown in FIG. 1b). Because all optical components, including projector 10, lens 14 and mirror 18, are fixed on the optical bread broad, the focus position of projected image is static. But the relative focus position of the projector in the resin vat is able to be adjusted with the linear motion of the vat 22 which makes the focus adjustment during the printing process controllable.

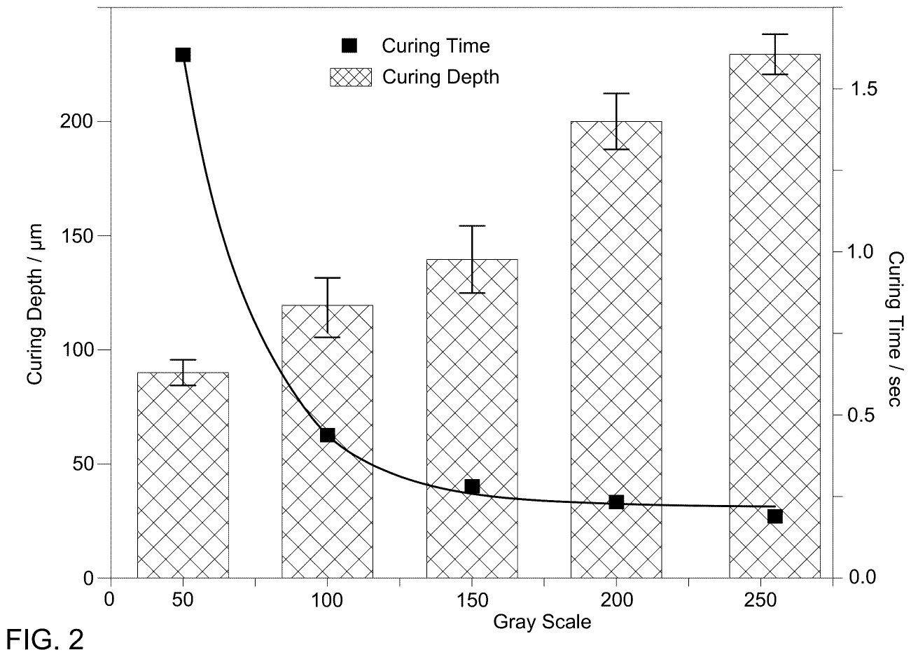

To set an appropriate printing speed, the curing characteristics of photopolymer has to be explored first. Based on the chemical mechanism of photopolymerization, a mathematical model is as follows:

$${C}_{d} = {D}_{p} ln ( E / {E}_{c} ) \qquad ( 1 ‐ 1 )$$

where C_{d} is curing depth, Dₚ is light penetration depth, E is energy input and E_{c} is critical energy density. Light penetration depth Dₚ is tightly related to the light absorber (e.g., dye) and the absorption by the photo-initiator. Then critical energy density E_{c} is determined by the PI characteristic. Since projection image dimension decide the energy density of the projection image for a given projector, the curing characteristics is tested at the focus position of the projector 10 where the projection dimension is set to be 60×45 mm². Different gray scale projection images are tested for the curing depth. Translucent UV-curing standard photopolymer resin (from ELEGOO Inc, Shenzhen, China) is used as main printing materials which means light penetration depth Dₚ and critical energy density E_{c} remains the same for all the tests. Under different gray scales of light exposure, the curing depth shows differences with each other (as shown in FIG. 2). High gray scale level means high optical energy which means E is large and 255 is the highest value in gray scale meaning full light exposure. Larger optical energy input E results in larger curing depth as shown in Eq. 1-1 which is consistent with the test results (as shown in FIG. 2). On the contrary, low gray scale means low energy input E which leads to smaller curing depth. Under full light exposure, the curing depth is the highest.

Curing time is also affected by light intensity because higher light intensity results in a faster photopolymerization reaction rate. As a result, higher grayscale level leads to a shorter curing time (as in FIG. 2). However, photopolymerization reaction rate has its own limitations because of photo initiator concentration so the change of curing time is less significant after the grayscale level is higher than 150.

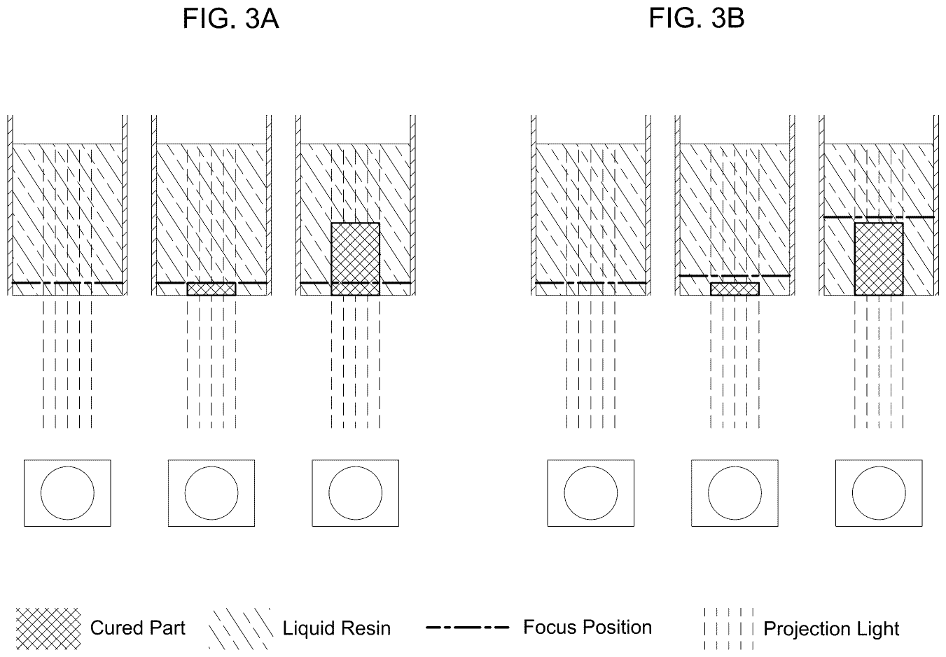

There are two different printing strategies for the LIDG process which are objects printing without focus adjustment and objects printing with focus adjustment. Both strategies are further explored and compared to determine the more advantageous method. In the no focus adjustment printing strategy, the resin tank is static during the whole printing process and the focus position is at the bottom of the vat (as shown in FIGS. 3a-3b). In this case, the optical energy distribution model is only affected by two aspects. The first one is projection image deciding the XY distribution of input. The other one is the growth of cured photopolymer since liquid and solid photopolymer have different optical properties, especially different effective absorption coefficients which dramatically influence the optical energy distribution along the Z axis (the direction of light transmission). Additionally, the curing image is blurred after the height of the solidified structures reaches a certain level resulting in unconcentrated energy distribution and vague projection image on the curing layer.

In contrast, focus adjustment printing strategy moves the resin tank continuously while printing, and the ideal case is that the projection image is always focused on the layer where the photopolymerization is happening (as shown in FIGS. 3a-3b). In this strategy, the optical energy is concentrated on the curing layer and the projection image is clear. However, a series of issues need to be resolved rose because of the adjustment of focus position. To be specific, the focus adjustment causes the variety of optical energy distribution both in XY plane and along Z direction and the variety becomes more complex with the combination of part growth during the printing process. Moreover, the determination of focus movement speed is important to this printing strategy and wrong speed setting may lead to even more vague projection image at the curing position.

Both printing strategies have their own advantages and disadvantages. No focus adjustment printing strategy is convenient for the fabrication of structures with large cross section area and small height and easy to accomplish and modify according to the printing results. However, the unconcentrated light limits the full potential of LIDG fabrication speed and the blurring of projection image after a certain height restrict the capability of producing tall part with accuracy. On the other hand, focus adjustment strategy leads to further complexity of modeling the optical energy distribution resulting from the introduction of relative movement between focus position and photopolymer. However, if a detailed mathematical model is created to describe the optical energy distribution and further optimization is applied to improve the accuracy, this strategy unleashes the full potential of the LIDG process.

As discussed above, no focus adjustment printing strategy is limited in several aspects but easier to accomplish. Besides, experiments by using no focus adjustment printing strategy can provide insights of the LIDG process. Therefore, this printing strategy is explored first for different exposure scales to better understand the growth speed and height capability of the LIDG process.

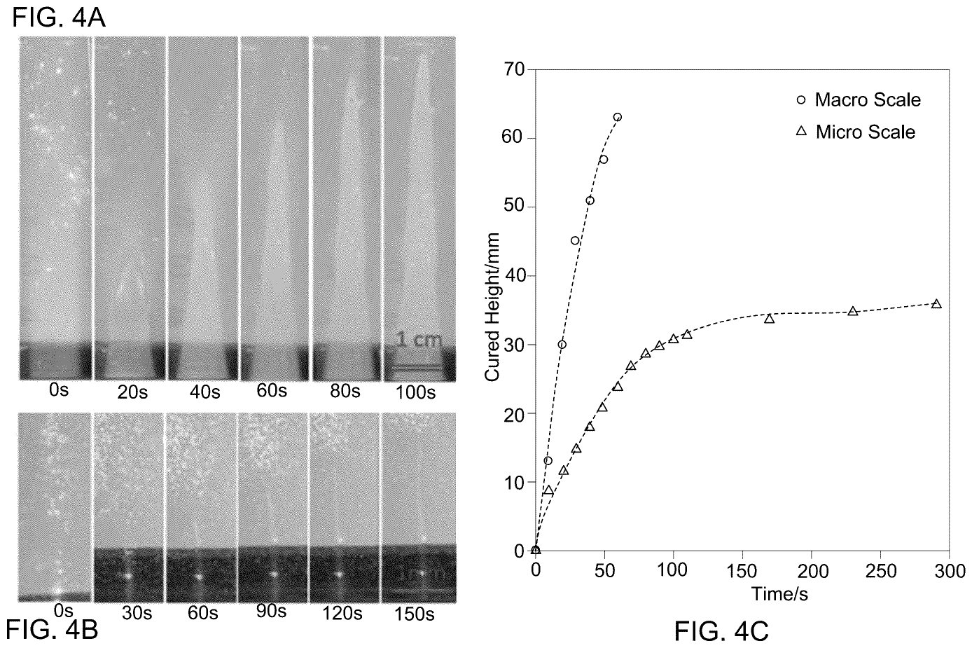

An image of a macro scale circle with diameter of 10 mm is projected and focused on the bottom of the resin vat and the growth process is recorded (as shown in FIG. 4a). Because the photopolymer used in the project is translucent, it is clear that the light can fully penetrate the whole liquid photopolymer even though the light intensity is decreasing along the optical path. At the start of the printing process, the photopolymerization happens at a high speed and the diameter of the solidified structure equals the diameter of the projected circle. Then, along with growth of the cylinder, the polymerization speed decreases, and the dimension of the fabricated structure shrinks as well. The reduction of polymerization speed is resulting from two main aspects. On the one hand, no focus adjustment means the optical energy is diverging away from the beam waist and lower optical energy is distributed on the voxels while curing sections away from the vat bottom. On the other hand, even though photopolymer is fully crosslinked, the solid structure still absorbs light energy resulting in less penetrated optical energy. With the combination of these two reasons, the part growth speed drops while the part grows inside the resin vat. As for smaller fabricated cross section, the different refractive coefficient of liquid polymer and solidified polymer leads to less concentrated light intensity and light shot on the side surface of the structure is further diverged away from the curing cross section. Therefore, only the light in the center section of the circle can reach the threshold to initiate the photopolymerization and then a smaller circle is cured. However, under longer time of exposure, the structure grows not only vertically but also horizontally because of the accumulation of the split light from the side surface. Additionally, the diameter of the bottom surface of the curing structure is also expanding because the scattering light accumulates around the bottom surface and initiates photopolymerization. In addition, to understand the relationship between the energy input level determined by gray scale level and growth speed, a series of images of 10 mm circle with different gray scale levels are utilized to printing cylinders with no focus adjustment. 60 mm height is set as a standard and the time taken to reach that height by using images with different gray scale levels are documented (as shown in FIG. 4c). The same difference between the gray scale levels results in dissimilar differences in growth time. This can be explained by the nonlinear relationship between the light intensity and the gray scale level. For instance, light intensity varies more when gray scale changes from 50 to 100 than when it changes from 200 to 250. This difference is quantified by modeling the light which is discussed in detail in the next section. As mentioned above, projection light can penetrate the whole liquid photopolymer which is the same for all projection images with gray scale levels ranging from 50 to 255. Besides, the growth of all macro scale cylinders can reach the full depth of the vat (65 mm) which means the capable height of the LIDG process without focus adjustment is beyond the setup limitation.

Also, a similar experiment is done for micro scale projection. According to Chi's research, because of pixel blending effect, macro scale and micro scale projection has different accumulated optical energy model, especially different amplitudes of the Gaussian function. Since the micro scale projection has smaller amplitude of the Gaussian function, the micro scale projection utilizes longer exposure time and has shorter light penetration depth. These phenomena are all reflected in the experiment results (as shown in FIG. 4b). An image of a 50 μm diameter circle is projected to print a micro-scale cylinder. Compared with macro scale cylinder printing, micro scale cylinder only grows one third height of macro scale cylinder within 30 seconds. In addition, a height limitation for micro scale cylinder fabrication is found since the growth nearly stops after the part reaches 34 mm (as in FIG. 4c). This occurs because the optical energy of micro scale projection is limited first and with the attenuation of cured cylinder and unconcentrated energy distribution, the optical energy diffused at each voxel is unable to reach the threshold where the generation speed of free radicals is faster than the consumption speed of free radicals because of oxygen. Therefore, beyond the limited height, the photopolymerization is not initiated anymore and the growth of parts is ceased. However, if a projector with higher power output is utilized in the setup, the height limitation is improved significantly.

In summary, there are several limitations existing in the LIDG process caused by the no focus adjustment. First of all, overcuring features at the bottom section of the part is hard to resolve since the focus is always located at the bottom of the vat in this printing strategy. Secondly, without focus adjustment, the projection image is blurred while curing upper section of the part resulting in the difficulty of controlling XY accuracy in the upper section. Lastly, the optical energy is not concentrated away from the waist of the light beam which leads to slower fabrication speed and shorter height limitation. However, the exploration of the LIDG process without focus adjustment provides the general fabrication speed range in the LIDG process and difference between micro scale and micro scale fabrication which assists in pushing forward the research to focus adjustment printing strategy to accomplish the full potential of the LIDG process.

In focus adjustment printing strategy, the printing process is complicated with the introduction of relative movement between beam waist and liquid polymer. The complication is mainly due to three reasons. First of all, during the growth process, the solidified structure exhibits different optical properties with liquid photopolymer which means the optical energy distribution is unsimilar in cured and uncured sections and continuously change because the photopolymerization continue happening. Secondly, the superposition of exposures from the vat bottom result in adequate optical energy deposition in voxels. So, the accumulation of exposure is important to be evaluated in the LIDG process. Lastly, the projection light is not parallel but has a beam waist along the transmission direction meaning that the light distribution in the liquid polymer is relatively varying by itself with the focus adjustment even without photopolymerization. Therefore, optical energy distribution modeling with consideration of the above three effects is necessary for printing with focus adjustment aiming for improving printing accuracy, speed and capability. To be specific, the procedure to explore printing with focus adjustment should follow these steps sequentially which are modeling of optical energy distribution, main process parameters exploration for micro scale and macro scale printing and optimization of the process for high resolution. Below sections of this proposal follow the same logic.

As discussed, the modeling of optical energy distribution is important for the LIDG process. To build mathematical model reasonably, the distribution model of the light itself is built first without introduction of further medium (solid and liquid photopolymer in this project). Then, on the basis of an analytical model of light transmission in a single medium, the energy distribution model in cured photopolymer and in pure liquid resin are built separately. To construct the model, optical properties of solid and liquid photopolymer are measured and investigated. Next, with the light transmission model in both cured and uncured resin, the optical energy distribution model is obtained with the knowledge of thickness of cured section. Eventually, the final accumulated energy distribution model is generated by combining a series of energy distribution models during the printing process.

In order to accurately model the projection light, the modeling of a single pixel is necessary at first since the image generated by a DLP projector is formed with a number of pixels. According to Chi's paper, the light intensity of a pixel follows a Gaussian function. Then with the aim of modeling the light energy distribution of a single pixel, single pixels with different gray scales are projected onto a thin layer of liquid polymer and a high-quality digital camera is utilized to capture the projected light. With the assistance of MATLAB, the brightness of the taken photos are digitalized and stored in matrices for different gray scale levels. Even though the experiments are conducted in a dark room, background light is still unavoidable which is considered as noise introduced by the camera. Since the whole experiments are conducted under same environmental conditions, the lowest values in the matrices are selected to represent the brightness of background light and subtract this value from all values in the matrices. Then, the highest value is selected to standardize the measured brightness values. To be specific, all values are divided by the highest value and all values linearly transfer into a value between 0 and 1. In this case, the standardized matrices are able to reflect the relative light intensity accurately. Additionally, the x and y values are generated based on the resolution of the taken photos which is not meaningful for the modeling of single pixels. However, there is a reflection relationship between pixel size of the photo and the pixel size of the DLP projector. Then, the original x and y values can be converted to the scale of pixel size of the projector which have physical significance. Finally, by fitting the matrices with Gaussian functions (Eq. 1-2), a series of 2D Gaussian functions approximating light intensities of different gray scale levels are obtained and the parameters of Gaussian functions are listed in Table 1.

$$f ( x , y ) = A \times {e}^{( - ( \frac{{( x - {x}_{0} )}^{2}}{2 {σ}_{x}^{2}} + \frac{{( y - {y}_{0} )}^{2}}{2 {σ}_{y}^{2}} ) )} \qquad ( 1 ‐ 2 )$$

In the Gaussian function, A represents amplitude, x₀ and y₀ means the center of the Gaussian function is located at (x₀, y₀), σₓ and σ_{y} stand for standard deviation along X and Y axis. Since the model of single pixel is not put into a specific coordinate, x₀ and y₀ are all set as 0. From the measurement results, σₓ and σ_{y} are similar with each other for the same Gaussian function and has small effect on further modeling. To simplify further modeling and optimization calculations, the average of σₓ and σ_{y} is used to model the light intensity distribution for single pixels, denoted as σ.

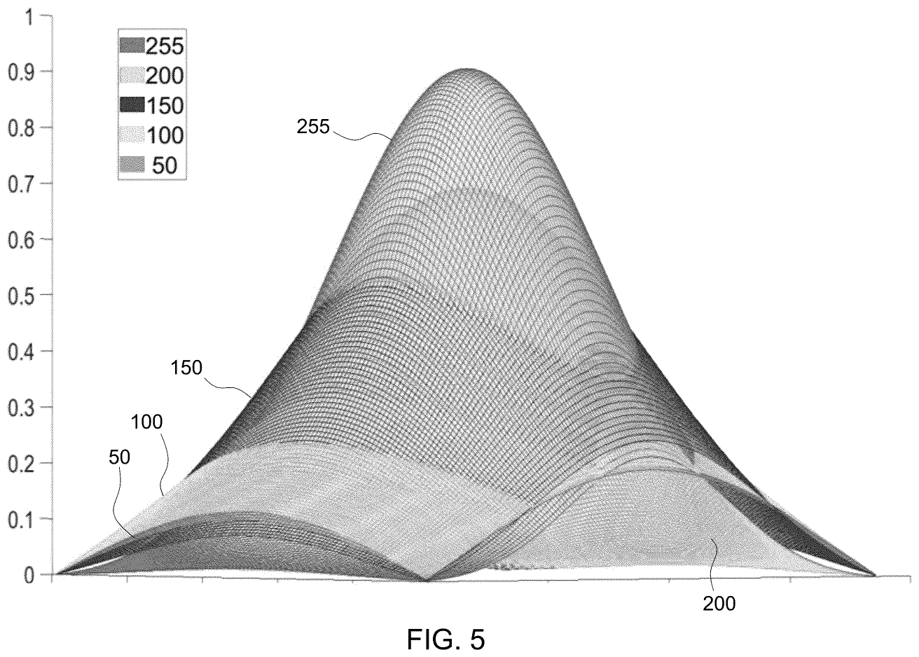

On the basis of the parameters listed below (as in Table 1), the optical energy distribution models of single pixel with different gray scale levels are accurately built and plotted (as shown in FIG. 5). As the data shows, the relationship between grayscale level and amplitude of light intensity are not linear and with further exploration, the data fits into a logistic function.

TABLE 1
Parameters Of Gaussian Functions for Different Gray Scale Levels.

| Grayscale Level | A (Amplitude) | σ (Standard deviation) |
|---|---|---|
| 255 | 0.9119 | 1.4800 |
| 200 | 0.8956 | 1.4734 |
| 150 | 0.7404 | 1.9835 |
| 100 | 0.6299 | 2.9581 |
| 50 | 0.5071 | 3.0333 |

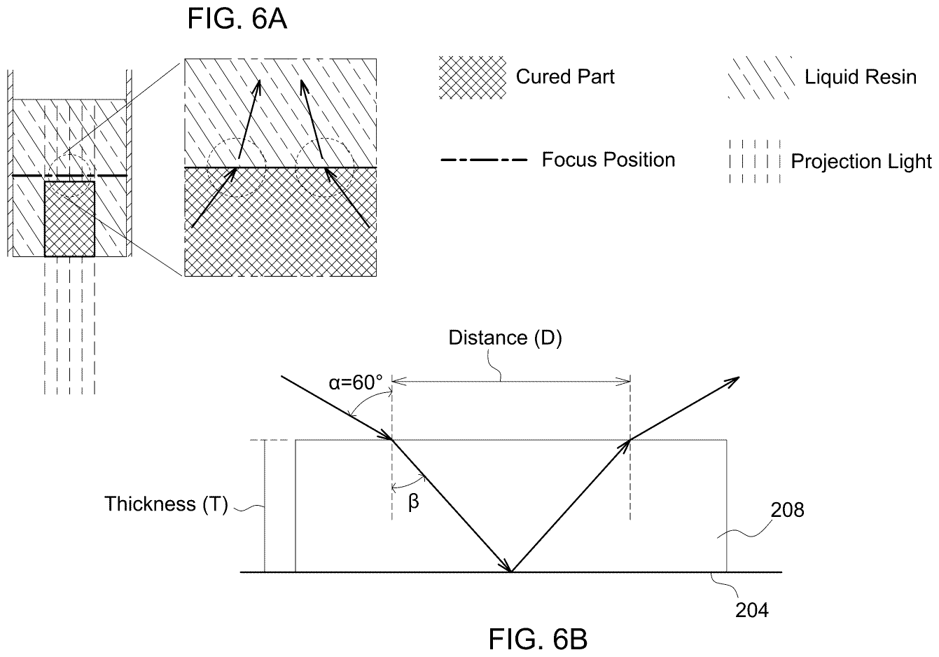

In order to model the optical energy distribution in 3D space accurately, light refraction is an important factor to be considered in light transmission. Since liquid resin and solidified structures have different refraction indexes, a setup is built for the measurement of both status materials (as shown in FIGS. 6a-6b). A laser beam is set at an angle of 60 degrees which is the angle of incidence and a small vat with specific depth is utilized to contain the liquid or solid polymer. At the bottom, a reflective mirror 204 is applied to reflect the light beam back to the top surface of liquid or solid polymer 208. Two beam dots is stably shown on the top surface and the distance D between two dots can easily be obtained. Because the thickness T of the material is determined by vat depth, which is a known value, the angle of refraction β can be calculated based on the equation.

$$β = {tan}^{- 1} ( \frac{D}{2 T} ) \qquad ( 1 ‐ 3 )$$

On the basis of Snell's Law of refraction and the knowledge of both angle of incidence and angle of refraction. The refractive index can be acquired from the following equation.

$$n = \frac{sin ( α )}{sin ( β )} \qquad ( 1 ‐ 4 )$$

The measurement result is that refractive index of liquid is 1.055 and the refractive index of solid is 1.193. Both the refractive index is between liquid or solid polymer and air, but in actual printing process, the refraction happens at the interface between the solid part and liquid resin. To be specific, the projection light is transmitted from the solid to the liquid. The refractive index for the light transmission crossing solid/liquid interface can be calculated by the below equation:

$${n}_{S / L} = \frac{{n}_{L}}{{n}_{S}} \qquad ( 1 ‐ 5 )$$

Therefore, the refractive index between solid and liquid polymer is 0.8843.

In the LIDG process, the light needs to penetrate the cured structures before reaching the curing layer and while during the penetration process, the optical energy is attenuated. Therefore, it is important to evaluate the attenuation effect of solidified polymer. Furthermore, optical energy not only passes through the solidified polymer but also the liquid resin. Since the actual photopolymerization occurs when the accumulated optical energy reaches the threshold, the amount of light energy distributed on further layers are calculated which as well utilizes the attenuation property of liquid polymer.

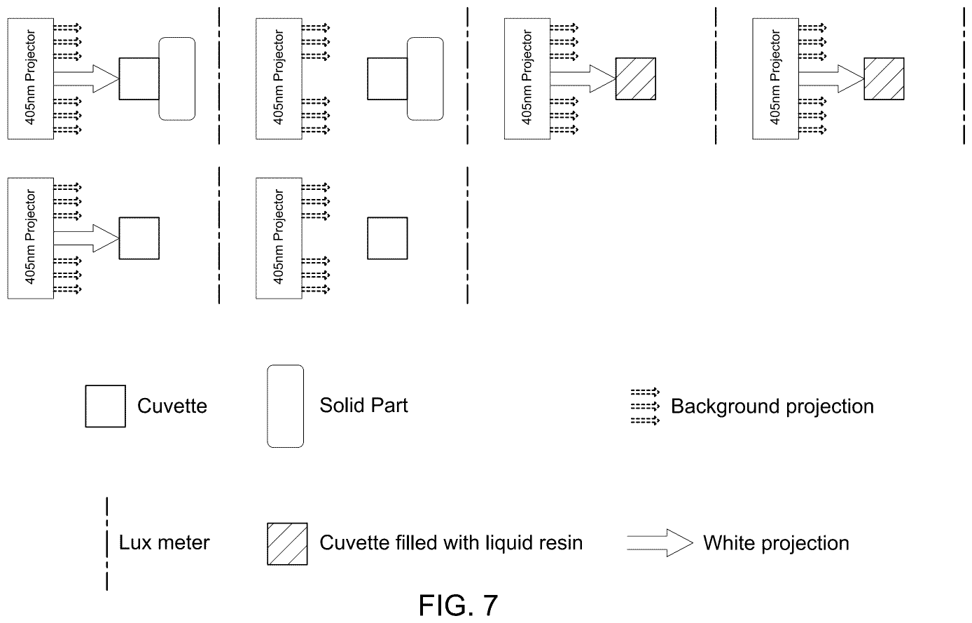

To explore the attenuation property of both solid and liquid polymer, different light intensities are measured under different conditions (as shown in FIG. 7). A solid polymer is cured using liquid resin which has flat front and back surfaces to avoid any deflection of the projection light with thickness of 12.85 mm. Since cuvette has to be included in the test as the container for liquid polymer, a cuvette is also included in the test for the measurement of solid polymer. To further eliminate the effect of a cuvette in the final calculation, the light intensity after penetration of cuvette is also measured as a controlled experiment. Additionally, even though the measurements are conducted in a dark, the background light of projector still can influence the accuracy of measured attenuation effect since the dimension of background light is larger than the used cuvette. Therefore, the light intensities are measured with only background light projection for all three mediums. In summary, the light intensities after passing through three mediums which are solid polymer with cuvette, cuvette filled with liquid resin and only cuvette are evaluated for two different projection mode: white square projection with background light projection and only background light projection (as shown in FIG. 7). The measured data are listed in Table 2. A lux meter (LX1330B Digital Illuminance Light Meter, Dr. Meter) is utilized to measure the light intensity. All components in the tests are fixed to avoid any disturbance. the light intensity.

TABLE 2
Light intensity measurements under different conditions

| | | | Background + | |
|---|---|---|---|---|
| | | Background | Square | Only Square |
| Mediums | | Projection | projection | projection |
| Cuvette + Solid part | | 59 lux | 376 lux | 317 lux |
| Cuvette + Liquid | 66 lux | 184 lux | | 118 lux |
| resin | | | | |

| | | | |
|---|---|---|---|
| Cuvette | 112 lux | 639 lux | 527 lux |

The calculation of attenuation effect is based on the Beer-Lambert Law (as in Eq. 1-6). Usually, the light intensity/is expressed in the unit of W/m². However, the unit of lux can be linear transformed from the unit of W/m² while using a single wavelength light source is used, so the light intensity expressed in lux can be directly applied into the Beer-Lambert Law to calculate the attenuation coefficient μ of solid and liquid polymer. The calculation results are μ_{L}=0.1489 W/mm and μₛ=0.0396 W/mm.

$$I ( z ) = {I}_{0} {e}^{- μ z} \qquad ( 1 ‐ 6 )$$

With the knowledge of the attenuation coefficients of the solidified part and liquid resin, the accumulation effect can be modeled on the basis of attenuation effect. The build of part can be sliced into layers and the layer thickness is denoted as ΔT. To clarify, the layer is only referred to the position and no actual layer exists in the final printed part since the LIDG process is conducted in a continuous manner. The light intensity and deposited optical energy at each layer can be calculated by using Beer-Lambert Law. Furthermore, the optical energy for the curing nth layer can be accumulated from the exposure for the first layer to the layer before curing layer and the curing time tₙ can be calculated by reaching the same energy level with previous layers. The results shows that the part growth speed in the LIDG process abides the following equation:

$$\frac{{v}_{n + 1}}{{v}_{n}} = exp ( - {μ}_{s} \cdot Δ T ) \qquad ( 1 ‐ 7 )$$

With the final purpose of achieving complex geometry printing with high resolution, the pattern of light transmission in cured and uncured resin are understood first. Light transmission in crystal follows the below mathematical model.

$${l}_{p} ( x , y , z ) = \frac{{C}_{0}}{{πω}_{p}^{2} ( z )} exp [ \frac{- 2 {( \sqrt{{x}^{2} + {y}^{2}} )}^{N}}{{ω}_{p}^{2} ( z )} - {α}_{eff} z ] \qquad ( 1 - 8 )$$

where, ω_{P}(z) indicates the diameter of pump light spot at position z, α_{eff} is the effective absorption coefficient of the crystal to the pump light, N indicates the order of the pump light (N=2 for gaussian beam, N>2 for super gaussian beam), C₀ is a constant and calculated by the following equation:

$${C}_{0} = \frac{{P}_{0}}{{\int \int }_{z = 0} \frac{1}{{πω}_{p}^{2} ( z )} exp [ \frac{- 2 {( \sqrt{{x}^{2} + {y}^{2}} )}^{N}}{{ω}_{p}^{2} ( z )} - {α}_{eff} z ] dxdy} \qquad ( 1 - 9 )$$

Where, P₀ is the pump power and the expression of ω_{P}(z) shows below,

$${ω}_{p} ( z ) = {ω}_{p 0} \sqrt{1 + {[ \frac{{θ}_{p} ( z - {z}_{0} ) n}{{ω}_{p 0}} ]}^{2}} \qquad ( 1 - 10 )$$

where, θₚ is divergence half-angle of pump light, z₀ is the position of beam waist, ωP₀ is the radius of beam waist and n is refractive index of the crystal.

In order to build the light transmission model in the presented case, a series of parameters needs to be calculated or obtained by experiments. θₚ, z₀ and ω_{P0} are basic properties of light source and can be easily measured. Refractive indexes n's of cured and uncured resin is obtained by previous experiments. Since light source used in this work generates gaussian beam, N=2. In the presented work, the goal of optimization is to construct an energy field where energy is uniformed and relatively high in the designed curing area and low energy (ideally no energy) is distributed in undesired curing area. Therefore, there is no need to calculate the exact light intensity at each voxel and only relative light intensity field is used. In this case, C₀ no longer needs to be calculated by using Eq. 1-9 and can be only considered as a constant related to gray scale, which simplify the model building greatly without sacrificing any description accuracy.

Effective absorption coefficient α_{eff} is the last and most tricky parameter to get. However, absorbance of photocurable polymer is easy to get by using spectrometers. The relationship between absorbance (a) and effective absorption coefficient α_{eff} satisfies below equation:

$${α}_{eff} = \frac{2.303 \times a}{T} \qquad ( 1 - 11 )$$

where, T is thickness of thin film and in this case the desired curing depth 200 μm. Besides, absorbance (a) also has a relationship with transparency as shown in Eq. 1-12.

$$a = {log}_{10} ( \frac{{I}_{0}}{I} ) \qquad ( 1 - 12 )$$

where I₀ is the intensity of the incident light and/is intensity of that light after it passed through the sample.

On the basis of Eq. 1-12, UV-Vis Spectrometers (Perkin Lambda 950) are utilized to measure the transparency of resin under different wavelengths. By incorporating Eq. 1-11 and Eq. 1-12, the effective absorption coefficient α_{eff} is obtained for liquid resin and solidified part. All the parameters are gained and ready to be used in constructing analytical models.

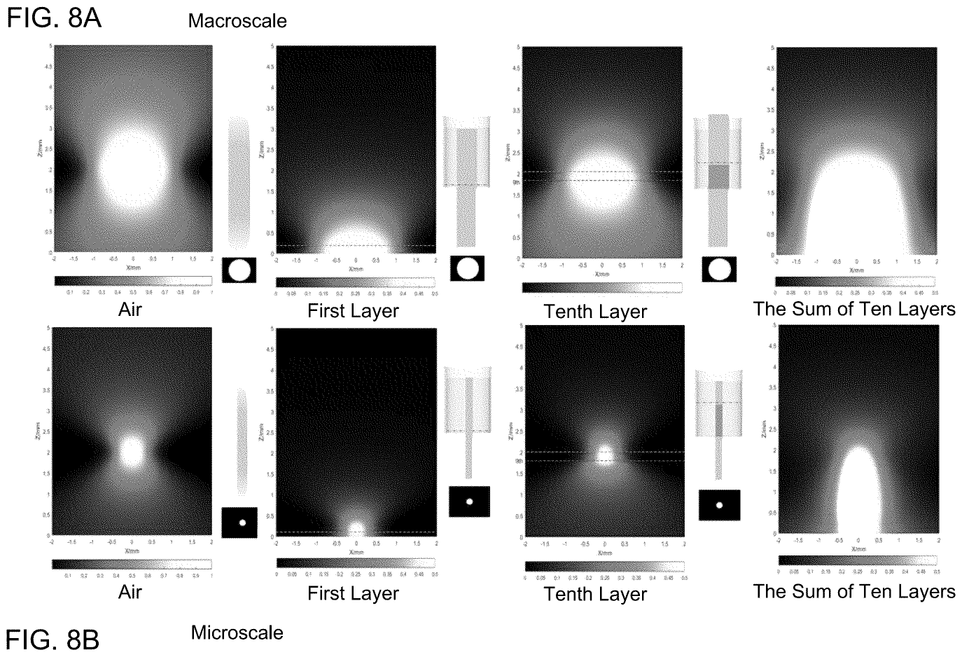

Assumptions that every light beam generated by single pixel can be considered as pump light source and the analytical transmission model of each light beam follows Eq. 1-8. Since the only effective wavelength initiating photopolymerization is 405 nm, the light source still can be considered as single wavelength pump light even though white light is used in this work. Thus, assumptions are justified. Then the light intensity distribution in 3D is the sum of energy distribution of all illuminated pixels. The models of macro and micro size light intensity distribution in 3D are simulated and drawn in MATLAB (as shown in FIG. 8a-8b).

In the previously discussed section, experiments show that the curing time remains the same for squares larger than 200² but varies greatly for squares smaller than 502. And this result is proved correct in the simulation. The maximum value of light intensity remains the same when the number of beaming pixels is larger than 200 and maximum value changes significantly when the numberer of beaming pixels is smaller than 50, which is referred as pixel blending. In order to show different transmission patterns, 200 pixels illumination is used as macro light and 10 pixels illumination is used as micro light beam. The transmission pattern with same focus position at 2 mm in air and liquid resin is compared (as shown in the first two columns of FIGS. 8a-8b). The main reason causing differences of the transmission patterns is effective absorption coefficient which indicates the absorption ability of medium. The air only absorbs little light energy (ideally zero energy), but the polymerization consumes considerable light energy.

With the aim of accomplishing multi-scale structures, micro-scale and macro-scale printing needs to be accomplished individually by using LIDG printing process. Since the fundamental curing mechanism is not changed, the difference between micro-scale and macro-scale fabrication processes lies on the accumulated energy level. As for a DLP projector, the optical energy distribution of each single pixel is not restricted within the scale of the pixel which leads to the energy blending of neighboring pixels. Therefore, there is a pixel number threshold beyond which the accumulated energy level is not affected by pixel numbers. Specifically, 50 pixels are the threshold to determine whether the projection is macro or micro scale in the DLP projector used in this project since the curing time for a square remains the same for projection images larger than 50 pixels×50 pixels. For projection images smaller than the threshold, the curing time varies depending on the dimension of projection image which means the accumulated energy level changes with pixel numbers within the range. Therefore, the curing characteristics of micro-scale projection are used for the accomplishment of the micro-scale fabrication.

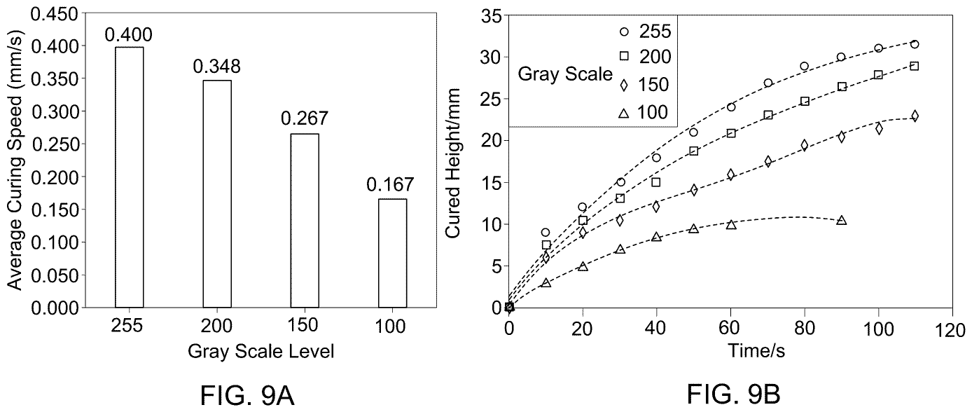

Printing speed is the first curing characteristic explored for the micro-scale printing process. A micro-scale mask image is projected to the resin tank filled with photopolymer. A preliminary test is conducted at first without moving the tank and the growth curve is recorded. Next, an average curing speed is obtained based on the growth curve and then the tank is moving continuously with the average curing speed. The growth curves of micro-scale projection with different grayscale levels are obtained by following the above steps. From the results, it is shown that lower grayscale level results in lower average curing speed and specially when the gray scale level is 50 or lower there is no photocuring observed since the optical light intensity is too small to initiate the photopolymerization (as in FIGS. 9a-9b). Additionally, a limitation of maximum curing height is observed in the micro-scale fabrication which is also related to projection light intensity. This is because in the LIDG process, the light needs to penetrate the cured section which has an attenuation effect and, in that case, if the optical energy is absorbed too much along the Z axis, the penetrated energy decreases below the threshold to initiate the free radical photopolymerization. Based on the experimental results of average curing speed under different grayscale levels, a mathematical relationship can be built between average printing speed and the grayscale level (as in Eq. (1-13)) (as shown in FIG. 9a).

$$V = 0.2529 ln ( g ) - 0.9977 for g \geq 100 \qquad ( 1 - 13 )$$

To further improve the printing quality of micro-scale fabrication, the accomplishment of micro-scale fabrication along z axis is important. With this aim, decreasing the light penetration depth is the most common solution which can be achieved by introduction of non-reactive dye in the resin. Specifically, Oil red O is used to lower down light penetration depth in this project. To better control the quality of micro-scale fabrication while using resin with dye, the relationship between dye concentration and curing characteristics is necessary. To be specific, dye concentration influences the absorption coefficient of the resin leading to different optical energy distribution based on the mathematical model (Eq. 3-8). An analytical model is generated to build the relationship between the optical energy distribution model and dye concentration.

The light intensity I(z) is given by Beer-Lambert Law (Eq. 1-6) and the characteristic penetration depth is defined as Eq. 1-14.

$${h}_{a} = 1 / μ \qquad ( 1 - 14 )$$

where hₐ is characteristic penetration depth and u is attenuation data.

The distributed energy E(z,t) for an exposure time of t is,

$$E ( z , t ) = t \cdot I ( z ) = t \cdot {I}_{0} \cdot {e}^{- z / {h}_{a}} \qquad ( 1 - 15 )$$

The critical photopolymerization energy E_{c} at depth z=zₚ is defined as,

$${E}_{c} = {t}_{p} {I}_{0} {e}^{- {z}_{p} / {h}_{a}} \qquad ( 1 - 16 )$$

where tₚ is the time it takes to reach the critical energy E_{c} at the position zₚ. Thus, zₚ represents the curing depth for a curing time of tₚ. For an optical intensity of I₀, the critical time T_{c} needed for optical energy reaches curing energy threshold E_{c} can be expressed as

$${T}_{c} = \frac{{E}_{c}}{{I}_{0}} \qquad ( 1 - 17 )$$

Using this definition, the curing depth can be solved as,

$${z}_{p} = {h}_{a} ln \frac{{t}_{p}}{{T}_{c}} = {h}_{a} ln ( {t}_{p} ) - {h}_{a} ln ( {T}_{c} ) \qquad ( 1 - 18 )$$

Based on this equation, hₐ is the slope in zₚ−ln (tₚ) plot. Additionally, increasing the Oil Red concentration decreases the characteristic curing depth hₐ and the functional relationship between characteristic curing depth hₐ and dye concentration C is given by:

$${h}_{a} = 1 / ( ε C ) \qquad ( 1 - 19 )$$

where ε is absorptivity and based on Eq. 1-14, the relationship between attenuation coefficient and dye concentration can be expressed as,

$$μ = ε C \qquad ( 1 - 20 )$$

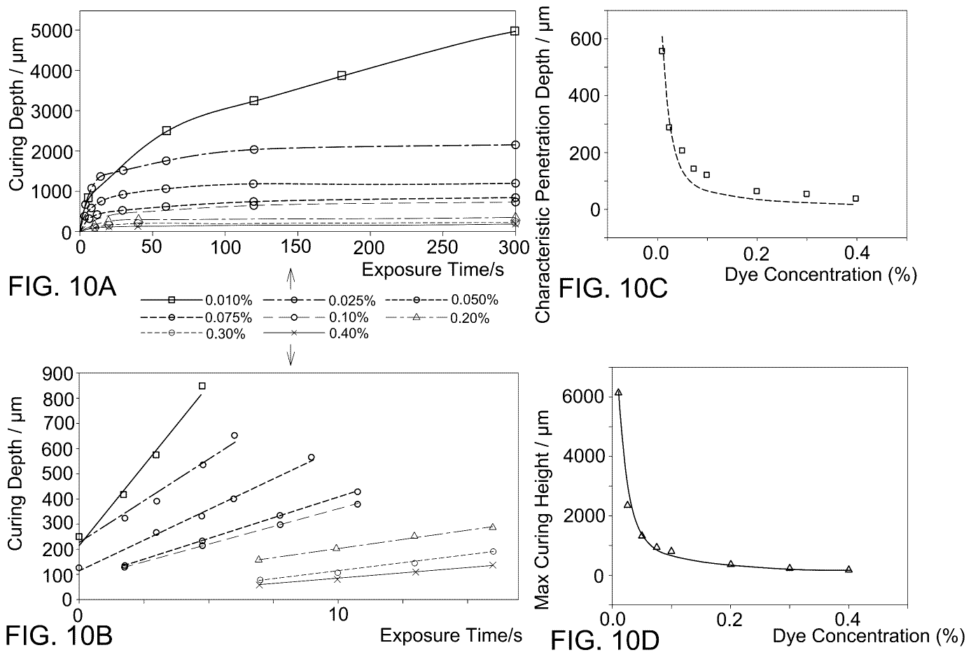

Thus, the key to building the relationship is find the absorptivity ε value of Oil Red O. With this purpose, a series of experiments are conducted to explore the curing characteristics of resin with different dye concentrations and then fit the model with the experiment results. By controlling exposure time for resin with different dye concentrations, a series of curing curves are established for all dye concentrations (as shown in FIG. 10a). It is clear that the addition of dye significantly decreases the growth speed and max curing height. Additionally, for resin with dye concentration higher than 0.025%, the growth stops after 120 s which means the optical energy can no longer reach the critical energy level after penetrating 120 s cured part. This dramatical change is because dye affects not only the optical transparency of liquid resin but also the transparency of cured resin. From previous results, it is known that photopolymerization is initiated when the addition of accumulated optical energy from previous exposure and current penetrated optical energy reaches the curing threshold. The introduction of dye decreases both energy input which leads to slower growth speed and shorter curing depth. Next, curing depth vs exposure time is plotted in logarithmic coordinate as in FIG. 10b and all the curves fit in linear models as expected.

Based on Eq. 1-18, the slope of each line represents the characteristic penetration depth for different dye concentrations which are obtained from the fitted equation for each curve. To get the absorptivity data for dye, fit hₐ (characteristic penetration depth) with C (dye concentration) according to Eq. 1-19 and ε=0.1645 μm⁻¹ for Oil Red O. And the attenuation coefficients can be calculated with Eq. 3-20 for resins with different dye concentrations. To further demonstrate the credibility of the model, the relationship between max curing height and dye concentrations is also fitted with power function as in FIG. 10d. The fitted model is used for resin selection for micro-scale parts with different heights.

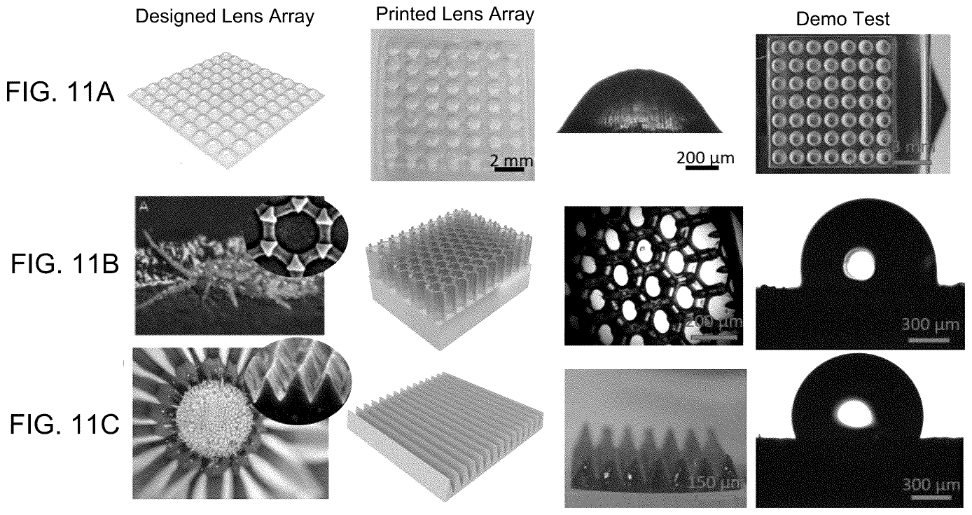

To demonstrate the capability of the LIDG process in the fabrication of micro-scale structures, a lens and two types of biomimetic structures are printed by the LIDG process. The whole lens array is fabricated with transparent resin and the whole printing process only takes 3 seconds. From the microscope side view image (as in FIG. 11a), the shape of the single lens fits the design. In the natural world, some micro surface structures exhibit hydrophobic and for instance the hierarchical surface structure in springtails and triangle array in daisy show superhydrophobic properties. By mimicking those natural structures, two micro-scale CAD models are designed and fabricated to demonstrate the capabilities of the LIDG process. By testing, the cured resin without any surface structure clearly shows an affinity to water. However, part with LIDG printed micro-scale surface structures exhibit hydrophobic property (as in FIGS. 11b and 11c). Specifically, the water droplet on triangle array surface structure has larger contact angle which means this type of structure is more hydrophobic. All the printed structures illustrate that the LIDG process is capable of micro-scale fabrication.

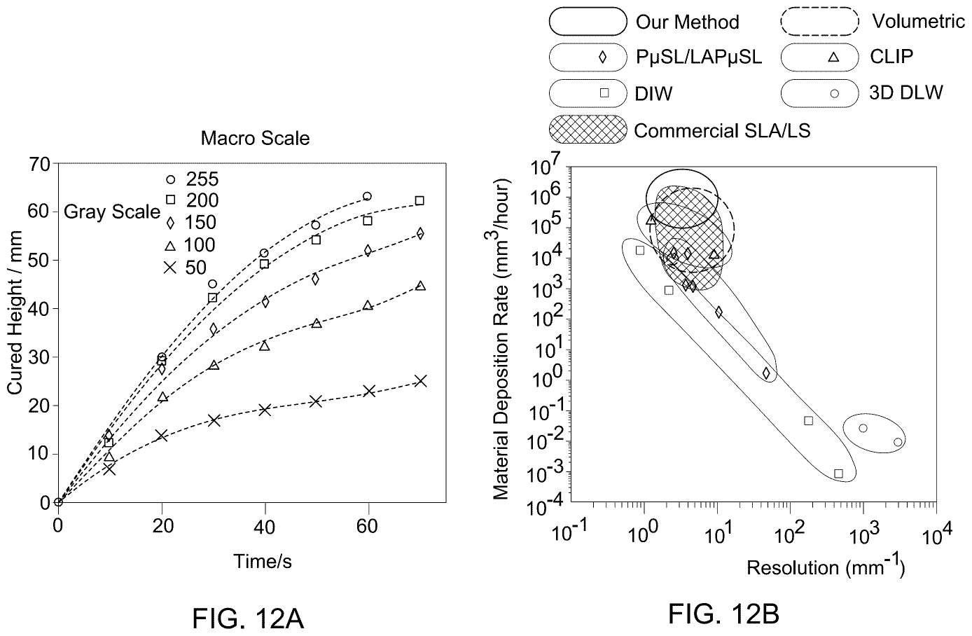

For macro-scale LIDG fabrication, the control of growth speed is important because the thickness is in mm scale for macro scale structures which means the loss of focus is more severe if growth speed does not match the move speed of resin vat. Different gray scale levels of macro scale circles are projected with focus adjustments and the whole growth processes are recorded using CDC camera. Therefore, the cured height and exposure time curve can be built for every gray scale (as shown in FIGS. 12a-12b). The growth speed for all gray scale levels decreases along with part growth, which can be explained by Beer-Lambert's Law (Eq. 1-6). The growth speed difference between the same gray scale gap is not identical and specifically, the speed changes larger while the gray scale is small. These results stay uniform with the amplitude results of different gray scale levels.

Based on the fabrication speed along z axis and the exposure area, the volume fabrication speed of the LIDG process can be calculated using the following equation.

$${V}_{V} = {V}_{z} \times S \qquad ( 1 - 21 )$$

where V_{V} is volumetric fabrication speed, V_{V} is z direction growth speed and S represents exposure area. Based on the recent research about VPP fabrication speed, the comparison between the present method and existing methods in fabrication speed and resolution can be determined (as shown in FIG. 12b). It is clear that the present method exhibits faster fabrication than most existing methods and at the same time the resolution is similar with other volumetric fabrication methods. Additionally, this method has little restriction on material selection.

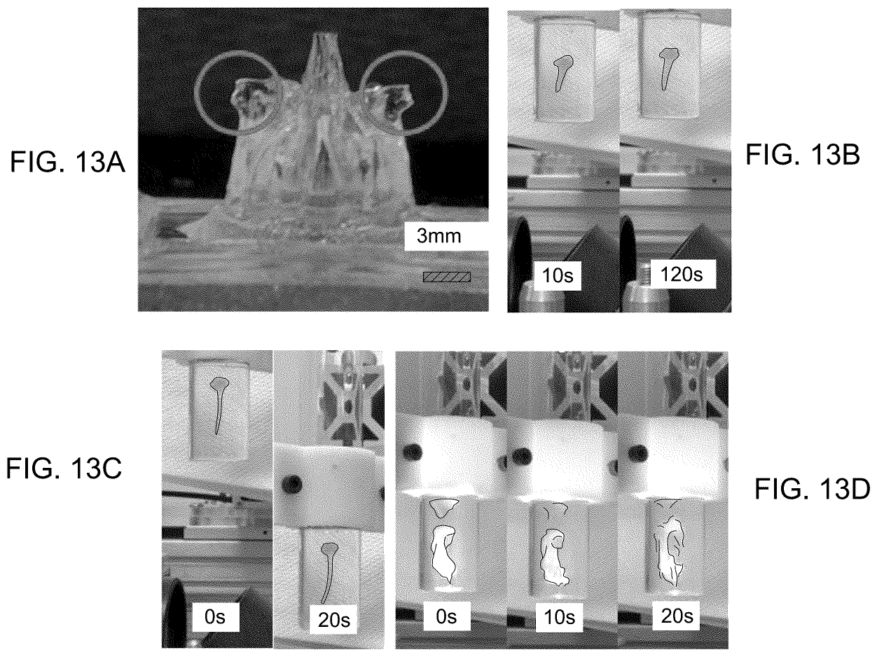

In macro scale fabrication, theoretically the upper section of the fabricated part is no larger than the bottom section but the fabricated tower using LIDG exhibits features in upper section which is larger than the bottom section (as shown in FIG. 13a). This may be attributed to movement of the curing gel during exposure. To be specific, during curing process, both exposure and photopolymerization generate heat leading to local temperature and liquid density differences. The liquid density differences is more evident in low viscosity materials and cause curing gel moving along with the part growth. To verify this assumption, dye droplet is placed in used resin to indicate the movement of resin under different conditions (as shown in FIGS. 13b, 13c, and 13d). First of all, a dye droplet is put in a still resin without any exposure as a reference test (as in FIG. 13a). Secondly, same resin with dye droplet is tested with only axis movement to verify whether mechanical movement causes liquid flow within resin vat (as in FIG. 13b). Finally, the influence of exposure on liquid flow is also explored with the help of dye droplets. Clearly, there is little movement of the dye droplets without any exposure. On the contrary, the dye moves significantly under exposure which verifies the previous assumption that curing gel moves under light exposure causing unwanted features and poor resolution in the fabricated parts. This phenomenon is more severe for low viscosity resin therefore it is important to find a viscosity which eliminates this effect entirely or minimum this effect to a scale causing no issues on the fabrication accuracy.

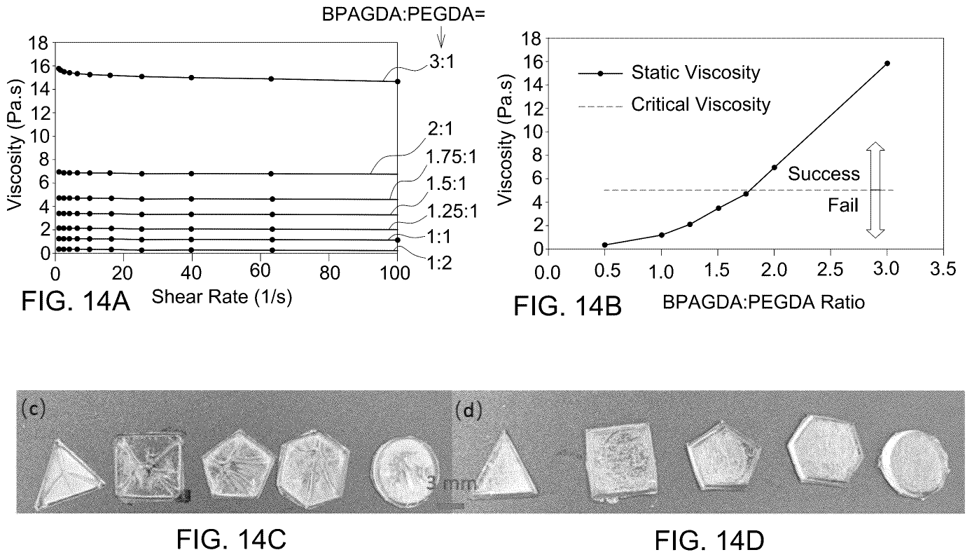

To find out the influence of exposure on liquid flow within resin vat with different viscosities, a series of photopolymer resins using different weight ratios of Bisphenol A glycerolate (1 glycerol/phenol) diacrylate (BPAGDA) and Polyethylene glycol diacrylate (PEGDA) are mixed. BPAGDA is a type of highly viscous material while the viscosity of PEGDA is similar to water. Both BPAGDA and PEGDA are commonly used to formulate photopolymer resin. Rheological behaviors are explored for resins made with different weight ratio of BPAGDA and PEGDA (as shown in FIG. 14a). Different structures are cured using these resins to determine the critical viscosity (as in FIGS. 14c and 14d) and specifically parts printed using resins with higher viscosity than critical viscosity shows no unwanted features in the top surface (as shown in FIG. 14d). The found critical viscosity is 5 Pa's in static condition (as shown in FIG. 14b) and the corresponding weight ratio of BPAGDA and PEGDA is 1.75.

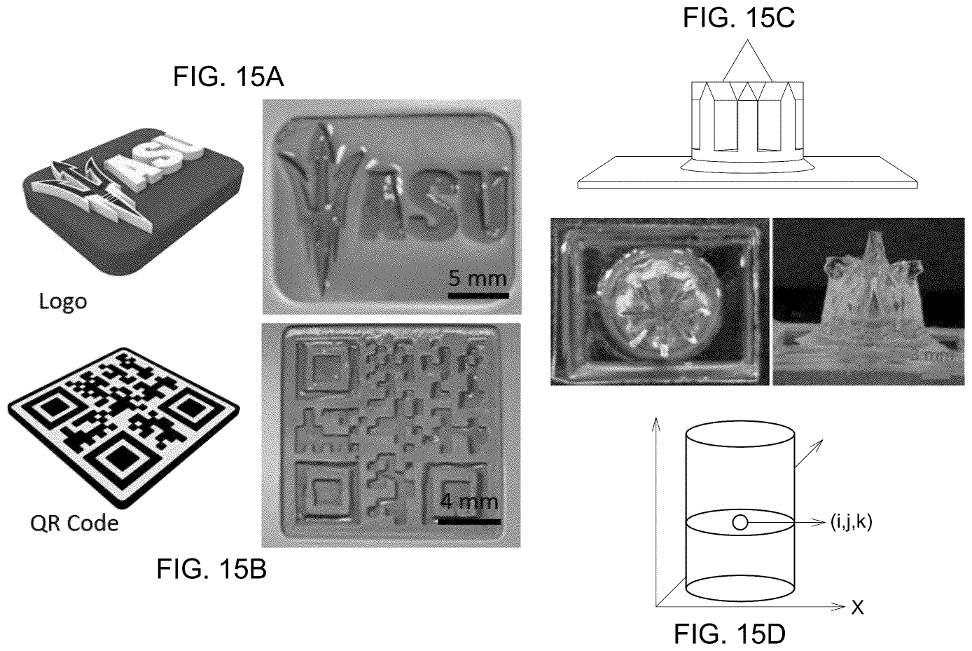

With the knowledge of fabrication speed and mathematical modeling, macro scale structures can be fabricated using the LIDG process (as shown in FIGS. 15a-15c). The ASU logo part is cured using resin added with 0.01 wt % dye (as shown in FIG. 15a) and QR code part contains both macro scale and micro scale (small rectangular dot) features which is printed with resin with 0.025 wt % dye (as shown in FIG. 15b). The tower structure is a macro scale structure with 25 mm height and clear resin without any dye added are used to ensure the curing heigh and fabrication speed. The whole part is printed only using 2 mins.

The energy is accumulated in the printing area. If using original sliced image, there is serious over curing formed at the bottom of the printed part. To solve this problem, the energy distribution of the printing area should be studied based on the generated optical model and the mask images to print each layer have to be optimized. To get the appropriate mask image to achieve the volumetric printing, the problem can be described as follows:
Given:
Target cured area in pixels: F(i, j, z) (i, j, z) is the coordinates in optical field
Penetration distance: P
Gray scale of pixel (i, j) in projection image at kth layer is Hijk
The size of the projection image: xmax:lk; ymax:wk
Light intensity related to gray scale of pixel (i, j) projection image at kth layer
Mxyz(Hijk)=Mijk(x, y, z) Hijk—need physical verification
Layer number: n-h/layer thickness
Error allowance: t
Find: gray scale setting H(i, j, k), δ critical curing energy value

$$\text{Satisfy:}$$

$${F}^{′} ( i , j , k ) = \{ \begin{matrix}1 , & ‖ I ( i , j , k ) - δ ‖ < t \\ 0 , & else\end{matrix}$$

$$where ,$$

$$I ( i , j , k ) = {\sum }_{z = 1}^{n} {\sum }_{x = 1}^{lz} {\sum }_{y = 1}^{wz} Mxyz ( i , j , k ) ( H ( x , y , z ) )$$

$$H ( x , y , z ) ϵ [ 0 , 1 ]$$

$$\text{Minimize:}$$

$${\sum }_{k = 1}^{n} {\sum }_{i = 1}^{w} {\sum }_{j = 1}^{h} \vert {F}^{′} ( i , j , k ) - F ( i , j , k ) \vert$$

The fake code is generated as below to create the optimal mask images:

1^{st} Step: Target Matrix Building

```
Given a target .stl file.
T = zeros (1024, 768, int(z/0.2)+1) (z is the thickness of the target part in mm)
Set n=int(z/0.2)+1, n total layer number or image numbers
For i=1:1:1024
  For j=1:1:768
    For k=1:1:n
```

| | |
|---|---|
| | If T(i,j,k) is inside the surface, |
| | T(i,j,k)=1; |
| End | End |

End
End

2^{nd} Step: Regular Slicing and convert images into 2d matrices

Image=zeros(1024,768,n)
For k=1:1:n
Image(:,:,k)=image(k)
End

3^{rd} Step: optimization

| | |
|---|---|
| I_xy_n=image(:,:,n) | %Final Layer pixel matrix |
| Z_n= 0.2*n; | %Final layer focus position |

Input I_xy_n and z_n into light distribution model get the following matrix
I_xyz_n
Max= max (I_xyz_n)
I_xyz=I_xyz_n/Max
For k=1:1:n
Image_modified(:,:,n−k) = I_xyz(:,:,n−k).*image(:,:,n−k);

| | |
|---|---|
| I_xy_k=image_modified(:,:,n−k); | %exposure pixel matrix |
| Z_k=0.2*(n−k+1) | %focus position |

```
  %Input I_xy_k and z_k into light distribution model get the following matrix
  I_xyz_k
  I_xyz=I_xyz+I_xyz_k
End
```

4^{th} Step: accumulation all layers and error estimate

```
I_xyz_final=I_xyz/(max(I_xyz))
For i=1:1:1024
  For j=1:1:768
    For k=1:1:n
```

E(i,j,k)=||I_xyz_final(i,j,k)−T(i,j,k)||

```
    End
  End
End
Final results:
```

| | |
|---|---|
| Image_modified (:,:,k) | %k=1:1:n |
| E(1024,768,n) | %error matrix |

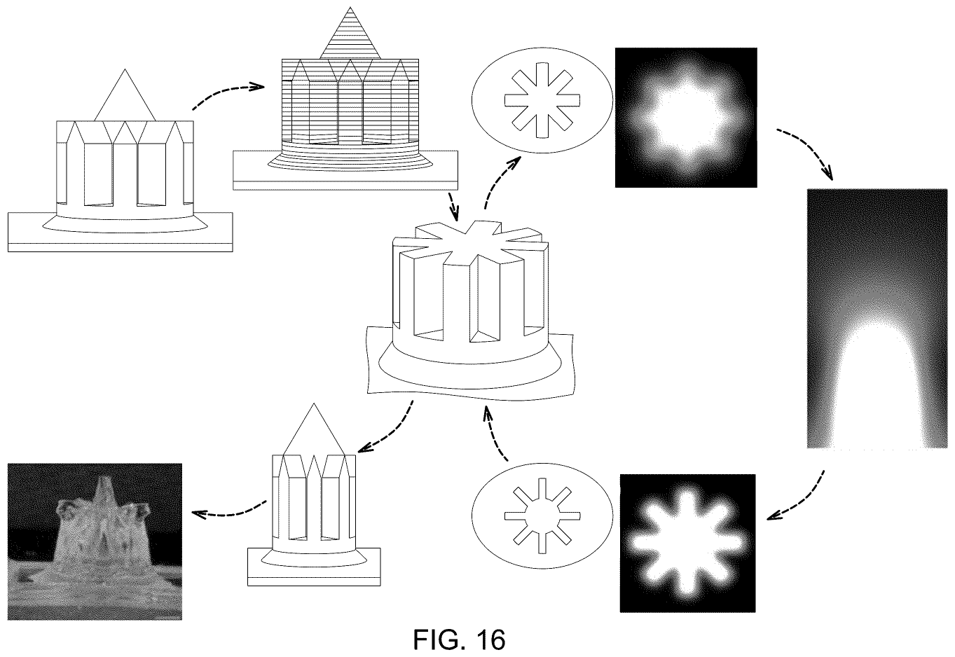

The overall process of mask image generation is shown in FIG. 16.

Central to the advancement of AM is vat photopolymerization (VPP), a process that has revolutionized additive manufacturing by enabling the production of exquisitely complex objects with remarkable precision. Historically synonymous with a layer-by-layer approach, new improvements in VPP have broadened its repertoire to encompass techniques such as clip and volumetric printing. Of them, volumetric printing stands out for its potential to transcend the limits imposed by layers, instead curing resin volumes inside a 3D space, hence giving unparalleled design freedom and production capabilities. These various techniques within VPP emphasize its rising potential across diverse sectors, from biomedical engineering to aerospace, promising to rethink manufacturing limitations and uncover new horizons of innovation.

Despite its transformational potential, present VPP procedures confront considerable hurdles that demand constant development and innovation. A challenge comes in generating high-resolution prints without sacrificing printing speed. Existing VPP systems generally deal with achieving a balance between resolution and speed, resulting to trade-offs that degrade overall print quality and efficiency. Moreover, VPP techniques usually demand support structures for overhangs and elaborate geometries, introducing complexity and extending post-processing times for print output. Another key problem refers to material qualities and stability, with changes in resin composition, curing times, and ambient conditions resulting in disparities in printed products' mechanical properties and reliability. Furthermore, scalability and cost-effectiveness remain significant problems in VPP, especially with large-scale industrial or commercial applications. The stated issues in present VPP approaches serve as the drive for this research initiative, which attempts to propose creative ideas to advance VPP technology and remove existing limits. By exploring novel procedures, adjusting resin formulas, and refining printing techniques, this study hopes to expand the capabilities of VPP and contribute to the continued evolution of additive manufacturing technology. Through interdisciplinary collaborations and concentrated research efforts, a future is envisioned where VPP stands at the vanguard of industrial innovation, providing unrivaled design flexibility, greater efficiency, and broader applications across numerous industries.

In summary, the combination of AM and VPP provides a transformational force with the ability to alter manufacturing and design environments. By addressing present obstacles and pushing the boundaries of technology, new opportunities are unleashed and pave the way for a future where additive manufacturing plays a major role in driving innovation.

The study opens with an overview of additive manufacturing (AM), concentrating on its transformational impact on traditional production. It moves to a discussion of VAT photopolymerization (VPP) methods, particularly emphasizing the importance of dual-wavelength continuous volume printing (DW-CVP) and the need of overcoming the problems inherent in this field role and foster innovation. The evolution of the literature critic's extensive AM and VPP methods is then analyzed from traditional layer-by-layer, clip and volumetric printing etc. to increase the quality of each method, to the definition of an extended analysis of systems the comprehensiveness of the comprehensive system. of existing research corresponding synthesized and identify areas for further research and innovation in the field of DW-CVP. The LIDG process with inhibition light is a novel DW-CVP.

The chapter goes to a full discussion of the experimental methods, including experimental design, resin manufacture, and printing factors Careful visits to preparation and printing techniques assure transparency clearly and reproducibly in the analytical process. Key findings relating to printing qualities, design, mechanical features, and other pertinent concepts considered in the experimental phase are elucidated Transitioning fluidly the narrative delves into a broader conversation where critically assessed and interpreted considering study objectives.

The limits of current VAT photopolymerization (VPP) techniques underscore the significance of continual improvement and innovation in the industry. One of the key issues facing VPP systems is obtaining high-quality printing without reducing print speed. Current VPP systems generally fail to balance resolution and speed, causing inescapable trade-offs that influence both print quality and productivity. Additionally, the reliance on overhangs and brittle geometric support structures continues to test VPP techniques, adding complexity and delay to the final printing process. Another key concern is the quality and stability of the printing substance. Variations in resin composition, cure time, and ambient conditions can cause inaccuracies in printed items, compromising their mechanical qualities and overall reliability. Furthermore, scalability and cost-effectiveness remain important issues in VPP, especially for large-scale manufacturing or commercial applications. The research has performed a complete examination of the issues facing conventional vat photopolymerization systems, offering novel techniques to remove these limits within the framework of the LIDG process with inhibition light. By employing dual-light sources, precise control over the photopolymerization process is aimed to be accomplished, allowing for the production of high-resolution prints at improved printing speeds. This invention has the potential to transform the capabilities of VPP technology, enabling the manufacturing of complicated and delicate components with unparalleled speed and accuracy. Moreover, the optimized resin composition is meant to reduce fluctuations in material properties and stability, providing consistent and reliable performance throughout printed items. The study indicates important leaps ahead in overcoming the constraints of conventional vat photopolymerization techniques and unlocking the full potential of continuous 3D printing. By solving major difficulties such as resolution-speed trade-offs, support system dependence, material quality, scalability, and cost-effectiveness, greater adoption of VPP technology across sectors is aimed to be promoted. Through continuing innovation and collaboration, VPP is predicted to evolve as a disruptive manufacturing technology, fueling growth and innovation for years to come.

The preparation of materials and methods is important for the LIDG process with inhibition light. It entails precisely formulated resin materials that include important compounds such as photo initiators and inhibitors. Researchers use systematic approaches to optimize material qualities and printing conditions, resulting in higher quality and shorter production times. The use of two light sources increases control over resin curing and inhibition. This study intends to push the boundaries of 3D printing, allowing for novel applications across industries.

The resin preparation procedure is methodically completed to acquire the needed characteristics and performance in subsequent tests. The formulation comprises precise ratios of the primary ingredients, namely triethylene glycol dimethacrylate (TEGDMA) and bisphenol A glycerolate dimethacrylate (Bis-GMA). These components synergistically contribute to the production of a polymer matrix with similar weights, ensuring efficient establishment within the resin. Moreover, the introduction of important catalysts such as camphorquinone (CQ) and ethyl 4-dimethylaminobenzoate (EDAB) at optimum weight percentages initiates the polymerization reaction used for resin solidification. This carefully regulated blend of components is important to the resin's structural integrity and functional effectiveness. Meticulous attention is made to managing the polymerization process under specified conditions. To do this, o-Chloro-4-isocyanatobenzene (o-CI-HABI), a photo-inhibitor, is included into the formulation at a concentration of 1% by weight. This chemical plays an important function in modulating the polymerization kinetics, ensuring that the process unfolds optimally within established parameters. Additionally, the solvent employed in the preparation procedure, containing a solution of tetrahydrofuran (THF) and o-CI-HABI in prescribed proportions, serves to aid the uniform dispersion of the resin components. This solvent-mediated dispersion mechanism is important in guaranteeing homogeneity and consistency throughout the resin mixture, establishing the framework for successful resin solidification and subsequent printing processes.

In the process of resin preparation for advanced 3D continuous volumetric printing, a systematic technique is important to acquire the desired material qualities important for effective printing outcomes. The process commences with polymer mixing, wherein specified ratios of TEGDMA and Bis-GMA are merged to generate a strong polymer matrix.

Subsequently, key catalysts like CQ and EDAB are precisely introduced into the resin mixture to commence the polymerization reaction, assuring structural firmness. The presence of o-CI-HABI as a photo-inhibitor modulates the curing process, important in maintaining optimal printing conditions.

Additionally, the injection of a solvent solution consisting of THF and o-CI-HABI aids in the uniform dispersion of components, ensuring uniformity throughout the resin solution. Through exact amalgamation and diligent blending, the resin attains near-100% precision in weight distribution, facilitating consistent material qualities. Following thorough mixing, a vigorous two-hour magnetic stirring process promotes homogeneity, followed by a settling time of 24 hours to eliminate air bubbles and solidify the resin solution. This rigorous preparation regimen ensures the resin's readiness for experimental operations, highlighting its important role in improving 3D printing technology and facilitating creative applications across numerous industries.

The utilization of a dual-wavelength light source is important in the suggested design for the LIDG process with inhibition light. This method allows unprecedented control over the photopolymerization process by utilizing two unique wavelengths: blue light for resin curing and UV light for inhibition. This arrangement allows for selective photopolymerization, with blue light initiating polymerization to solidify the resin and UV light preventing polymerization in specific areas, so enabling the fabrication of complicated geometries without the need for support structures. The orthogonal illumination arrangement ensures homogeneous exposure of the resin, facilitating even curing and inhibition throughout the printing process. The dual-wavelength arrangement optimizes printing characteristics such as curing time and intensity, permitting high-resolution prints with improved accuracy and surface smoothness while simultaneously enhancing printing speed and efficiency. This setup lowers print failures while enhancing overall print reliability and consistency by addressing common VPP technique concerns such as overcuring and resin adhesion problems. In conclusion, the utilization of a dual-wavelength light source is a versatile and effective solution for the LIDG process with inhibition light, enabling unsurpassed control and precision during the photopolymerization process. Additionally, volumetric printing circumvents limits imposed by layers by curing resin volumes within a 3D space, enabling unparalleled freedom in design and construction. This spectrum of technologies within vat photopolymerization highlights its predicted major position in numerous fields, including biomedical engineering. These multiple techniques underline its rising promise in different areas, from biomedical engineering to aerospace, promising to redefine the frontiers of manufacturing.

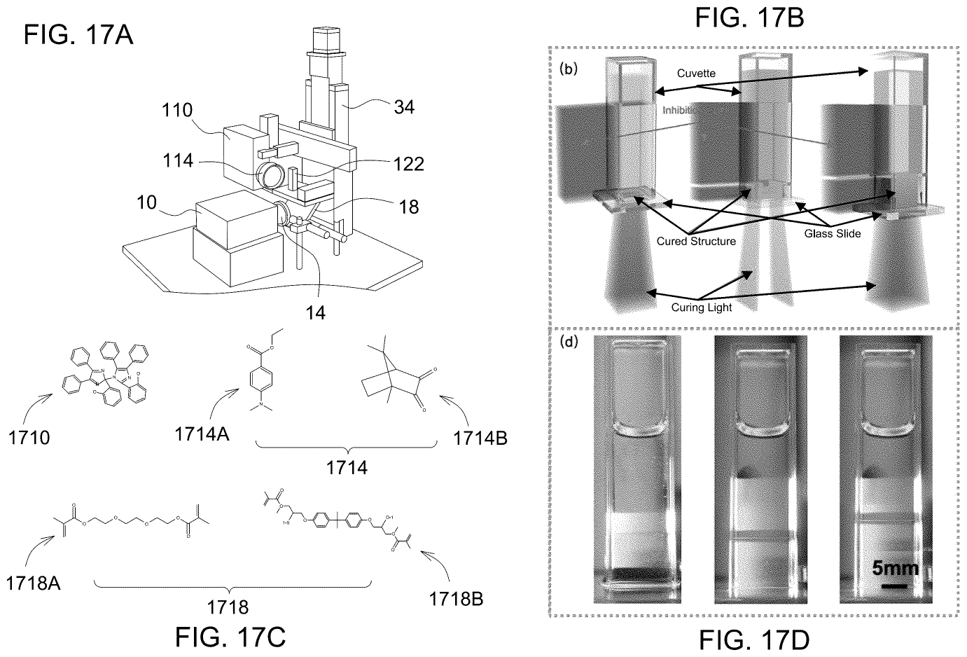

In the proposed AM method, two distinct light sources 14, 114 with different wavelengths are used. The setup as depicted in FIG. 17a is used to ease the printing process. Light source 14 with 458 nm wavelength serves as curing light which is shot horizontally at first and then reflected by a 45-degree arranged mirror 18. The 458 nm light 14 illuminate the resin in the vat 122 selectively from bottom to top as in the original LIDG process. Additionally, the inhibition projector 110 shots 365 nm inhibition light from the side (i.e., through a sidewall of the resin tank 122). In some embodiments, a convex lens 18, 118 is associated with each of the projectors 10, 110. Both inhibition project and resin tank 122 are mounted on the same linear stage 34 to accomplish simultaneous movement. On the other hand, the focus position of curing light is relatively moving within the resin tank by controlling the stage movement as in original LIDG setup. The simultaneous movement between inhibition projector 110 and resin tank 22 makes it easy to control the inhibition volume by only controlling mask images of inhibition projector 110. This whole approach provides fine control over additive synthesis. FIG. 17b demonstrates the printing process using a three-step example, exhibiting how each light source performs when printing a hollow-structure cube. The first step is to cure the bottom surface. The inhibition light exposes the whole resin tank except the bottom section where the curing light is focused and cures the bottom surface. To cure the hollow middle section, the inhibition happens below and above the curing layer leaving a layer possible to be cured by curing light. Lastly, the curing light focuses on the top surface position and the inhibition light prohibits any photopolymerization from happening in the hollow section and above the upper surface. This visual representation provides insight into the temporal evolution of the printing system by demonstrating the link between two printing system light sources.

Additionally, the chemical structures of all the components that went into producing the resin are presented in FIG. 17c. In particular, FIG. 17c illustrates a photo-inhibitor 1710, as shown, o-cl HABI, a photo-initiator 1714 (Ethyl 4-(dimethylamono)benzoate 1714A and Camphorquinone 1714B shown), and a polymer 1718 (Triethylene glycol dimethacrylate and etyle-4-dimethylaminobenzoate shown). Detailed resin recipe and preparation methods are already discussed in the previous section. This encompasses photo initiators, polymers, and photorefractory, each of which is important to the printing process. Lastly, the light inhibition gradient over the course of the three printing procedures is plotted, as shown in FIG. 17d. This picture depicts how light blocking impacts the curing process at different periods from the beginning to the finish of printing. This knowledge adds to the comprehension and refinement of the printing process, guaranteeing precise and fast manufacture of the attachments.

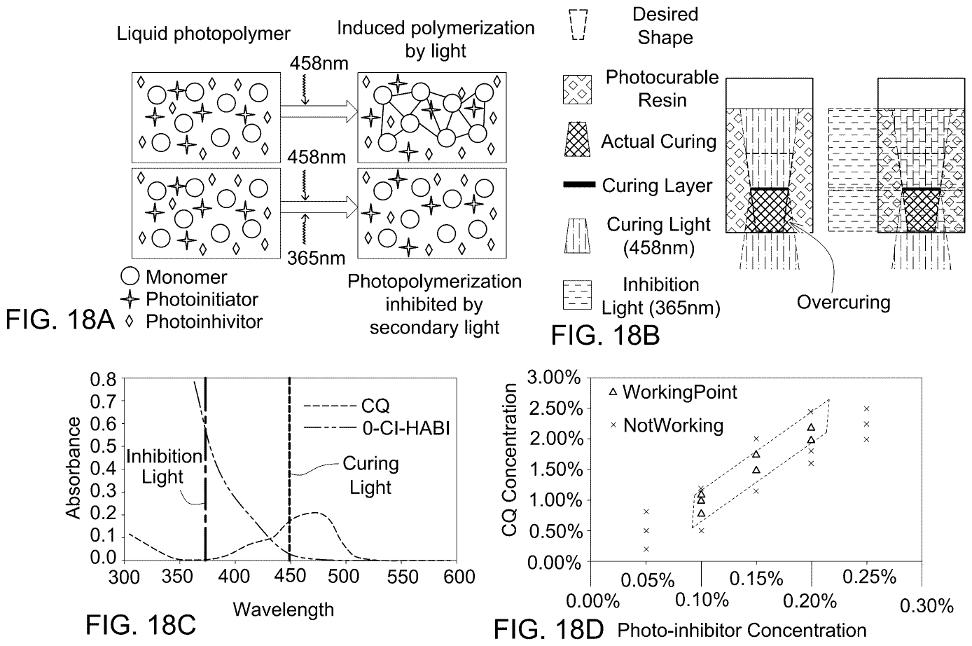

As shown in FIG. 18a, with the existence of inhibition light, the photopolymerization is ceased which can be explained chemically based on resin formulations. As mentioned above, CQ and EDAB serve as a visible light photo initiator and co-initiator, respectively, and o-Cl-HABI as a photo-inhibitor. Whereas HABIs are well known as effective photo initiators in the presence of complementary, hydrogen-donating co-initiators, in the absence of co-initiators, the lophyl radicals transiently generated upon HABI photolysis efficiently inhibit radical-mediated, chain-growth polymerization by rapidly recombining with propagating, carbon-centered radicals and thus can be used to prevent polymerization within the resin tank. With the introduction of inhibition light to the original LIDG process, the significant change is that the inhibition light makes the fabrication of overhanging geometric features possible in the LIDG process (as shown in FIG. 18b). If a larger cross area needs to be cured on top, without inhibition the cross area is cured below the target position before the target area is photopolymerized leading to unwanted overcuring features, however the cross area remains uncured below the target position as long as the inhibition light expose that area (as in FIG. 18b).

To understand what wavelength for photopolymerization and inhibition individually, the molecular absorbance spectrum of photo-initiator CQ and photo-inhibitor o-CI-HABI is plotted (as shown in FIG. 18c). Consequently, 458 nm wavelength is selected for curing light and 365 nm wavelength is chosen for inhibition light. Following that, different concentrations for photo-initiator CQ and photo-inhibitor o-CI-HABI are tested. Since EDAB serves as co-initiator for CQ, the ratio between CQ and EDAB remains the same to guarantee best photo-initiation performance and decrease the complexity and uncertainty in the formulation. For each concentration set, cubes are cured continuously based on the growth rate of each specific formulations and cubes with clear printing defects are considered as failed printing results. The printing defects include but are not limited to overcuring at bottom section, under-curing at top section and unpredictable growth rate. Then a clear working range of formulations is established based on the experimental results (as shown in FIG. 18d).

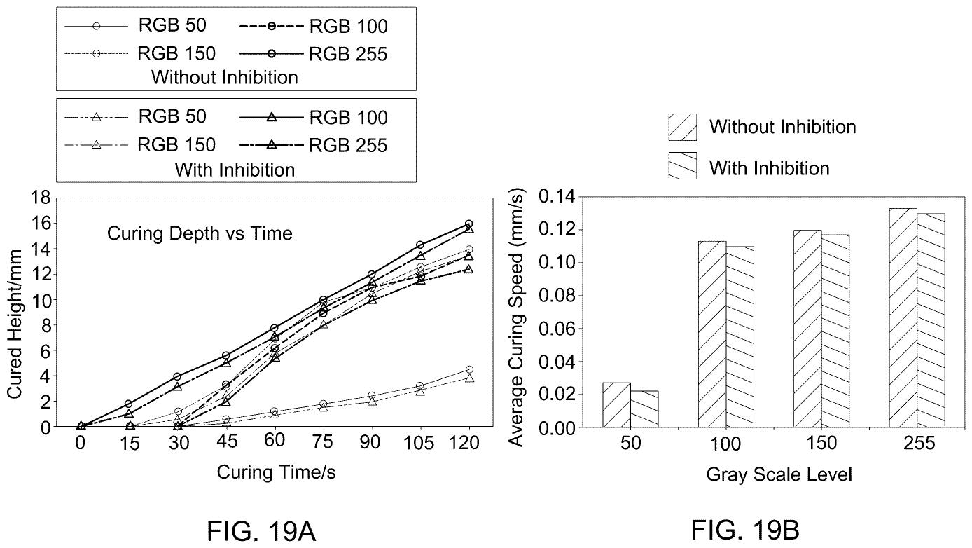

After the exploration of inhibition characteristics, the curing characteristics with and without inhibition light are determined. To be specific, curing without inhibition light is to conduct curing test only with one curing light source and curing with inhibition light means that the inhibition light is exposed to all resin tank except the area where photopolymerization happens. All tests are conducted with continuous z axis movement to avoid any blurring or off focus of curing light. The growth curves are plot for different curing time for different situations and curing light with different gray scale levels (as shown in FIG. 19a). It is clear that the existence of inhibition light slows down the growth speed for each gray scale level, but the decrease of growth speed is not large enough than the difference between different gray scale levels. Therefore, the introduction of inhibition light improves the fabrication capability greatly and has little effect on the fabrication speed of the LIDG process, which suggests that the introduction of inhibition light is a significant upgrade for the LIDG process. Similarly, the average curing speed can be obtained from the curing curves and assist in setting the continuous movement speed for LIDG printing with inhibition light (as shown in FIG. 19b).

After understanding the inhibition and curing characteristics, a printing process for LIDG with inhibition light is planned and evaluated. Three printing process plans are considered. First: printing with inhibition light exposed to only above the curing layer. Second: printing with inhibition light exposed to only below the curing layer. Third: printing with inhibition light exposed to above and below the curing layer.

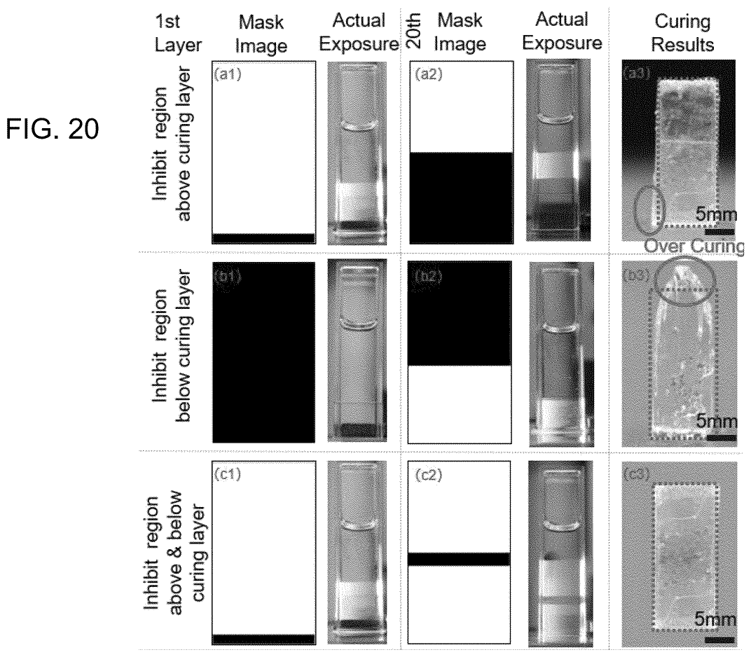

To further investigate and evaluate those printing processes, 20 mm high structures are printed with 10×10 mm square bottom surface using each printing process. The curing light for all three printing processes is identical and the difference lies in the inhibition light. It can be predicted that the third printing process is best option. From FIG. 20, the prediction is confirmed. The overcuring is hard to ignore and solve for process 1 even though the cross-section area is identical throughout the z axis. Process 2 eliminates the over curing features at the bottom of section; however, the growth speed is fast and hard to control without the top area inhibited. Therefore, under cure features appeared on the side surfaces and non-flat top surfaces came up because of fast and uneven growth speed for high part fabrication (as in FIG. 20).

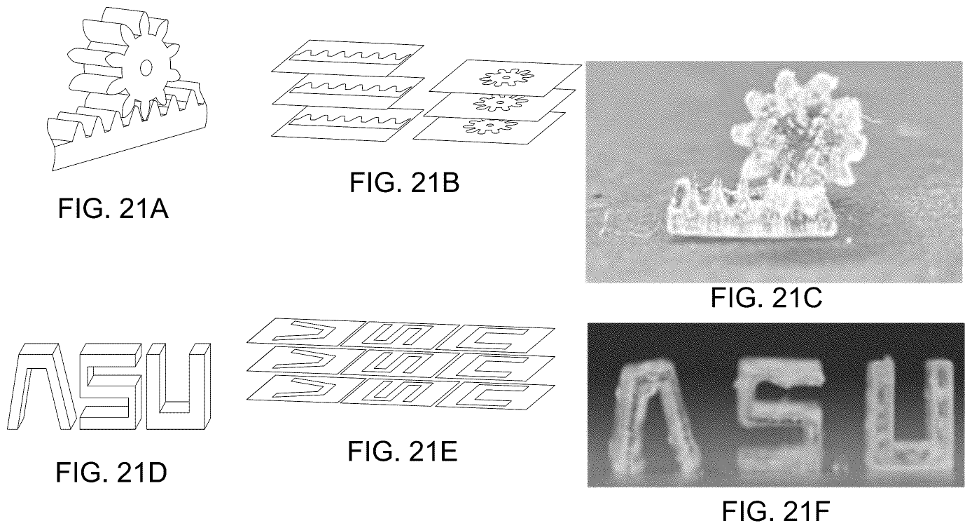

To demonstrate the capability of LIDG with inhibition light process, two demo printings are conducted which are gear & rack and ASU logo (as shown in FIGS. 21a-21f). For the two demo printings, the normal inhibition method is utilized as discussed above. Both demo printings show good accuracy without significant overcuring or under curing features. The good printing quality ensures that spear and rack fit well with each other, and spear can achieve a smoot rotation motion on the rack as expected. The flat top surfaces are easily accomplished.

LIDG is developed with inhibition printing technique. To accomplish this method, the setup is designed and constructed on the basis of the LIDG process setup. Then, the inhibition characteristics are explored for different formulations to find working ranges and the curing characteristics for different gray scale levels with and without inhibition lights. Following that, three different printing processes are planned and evaluated for this technique to establish the best printing process. By using the printing process, three demonstrations are conducted to show the capability of the LIDG process with inhibition light.

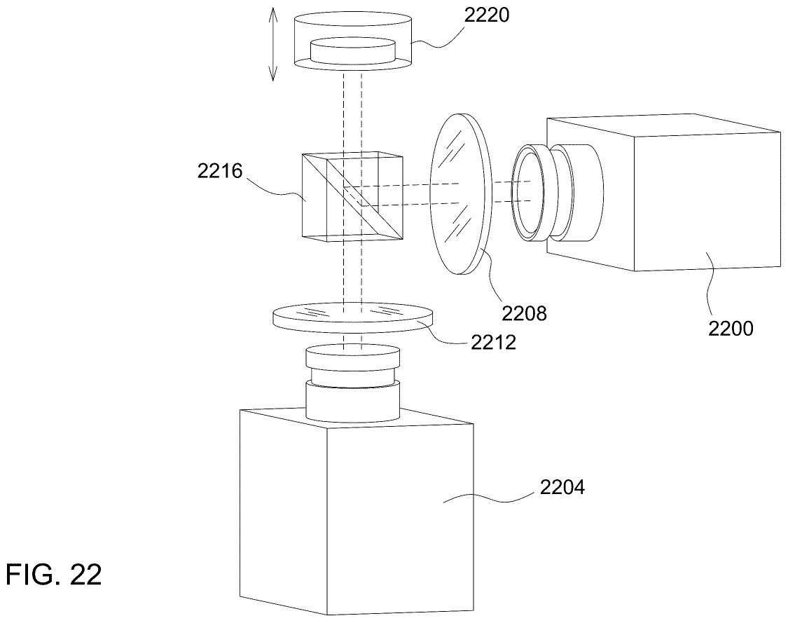

In LIDG with inhibition process, a secondary light source 2200 is added to inhibit the photopolymerization. On the basis of that, a different light source 2204 is added to initiate photopolymerization for a different type of material. However, unlike the LIDG process with inhibition light, both lights 2200, 2204 are curing light and need to shoot from the bottom of the vat 2220. Therefore, a beamsplitter 2216 is used. Multiple projectors 2200, 2204 and convex lenses 2208, 2212 and multiple setup arrangements are tested and all share the same optical module as shown in FIG. 22.

The core of the multiwavelength assisted LIDG process is the co-existence of two different light sources generating different wavelengths but focusing on the same position in the vat. Therefore, the setup calibration achieves a multi-material LIDG process by aligning two wavelengths before curing the resin.

Additionally, the reason why different materials can be cured by different wavelengths in a single mixed solution lies in the chemistry of photopolymerization. In photopolymerization, there are two main types of molecules: monomers and photo-initiators. No matter in which type of photopolymerization (free radical or cationic photopolymerization), photo-initiators are initiated by a certain type of photon, or a certain wavelength light and polymerization of monomers only starts when photo-initiators are active. Under this circumstance, as long as two different types of monomers utilize different photo-initiators and different photo-initiators are active only under exposure of different wavelengths, multi-material VPP printing is possible. However, things are much more complicated. The solubility between different monomers and different photo-initiators, the possibility of co-existence of different types of materials and interconnection between cured materials are issues that warrant consideration for material preparation.

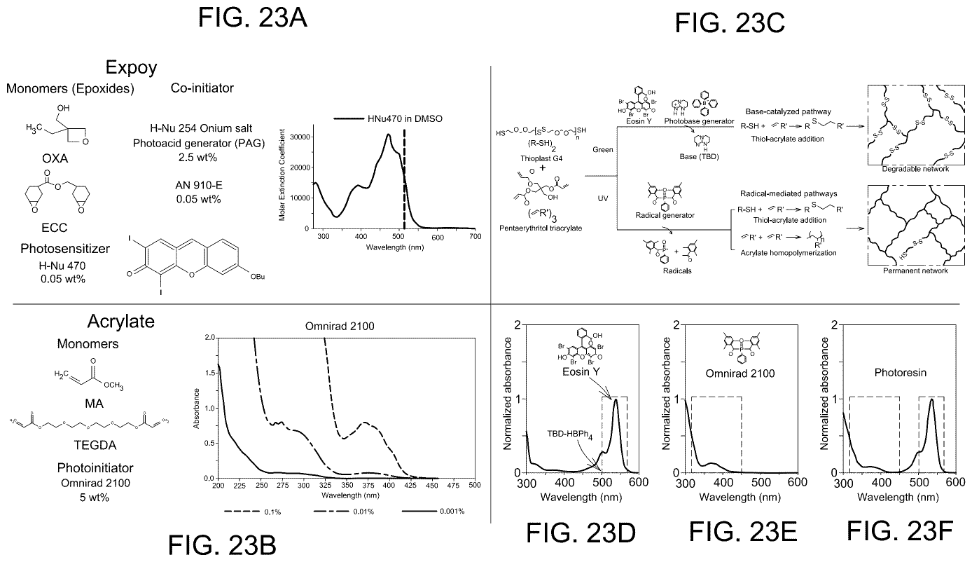

The first recipe is the combination of elastic acrylate material and glassy hard epoxy material. 3,4-Epoxycyclohexylmethyl 3,4-epoxycyclohexanecarboxylate (ECC) and 3-Ethyl-3-oxetanemethanol are used as epoxy monomers and H-Nu 470 is used as photosensitizer. H-Nu 254 and AN-910-E are utilized as co-initiators (as shown in FIG. 23a). Triethylene glycol dimethacrylate (TEGDA) and Methyl acrylate are used to formulate acrylate solution with Omnirad 2100 as photo-initiator (as shown in FIG. 23b). For epoxy formulation, 80:20 of ECC: OXA are mixed well with each other at first. Then add the initiators H-Nu 470 (0.05 wt % of mixture), H-Nu 254 (2.5 wt % of mixture) and AN-910-E (0.05 wt % of mixture). All agglomerating particles and lumps are broken to assist in the mixing. Fifteen minutes of ultrasonication and vortex are used to fully mix the initiators with the epoxy formulation. Then acrylate formulation needs to be prepared by mixing 99.5:0.5 of MA:TEGDA together with Omnirad 2100 (5 wt % of mixture). Fifteen minutes of ultrasonication and vortex are also used for acrylate solution. Then 3:1 of epoxy to acrylate is needed to generate the final solution for the multi-material LIDG process since acrylate cures at a much faster rate than epoxy.

The second formulation is thiol-acrylate photo-resin which needs to synthesize TBD-HBPh4 at first. First, approximately 1.4 g (about 10 mmol) of TBD is dissolved in 10 mL of a 10 wt % HCl aqueous solution (approximately 27.4 mmol HCl). Next, an aqueous solution of NaBPh4 is prepared by dissolving about 3.8 g (approximately 11 mmol) of NaBPh4 in 10 mL of deionized water (DI water). This NaBPh4 solution is then added dropwise to the TBD solution. The precipitated salt is filtered and washed twice with DI water and once with methanol. The salt is then recrystallized from a methanol/chloroform mixture (4:1 by volume) at 70° C. After recrystallization, the product is filtered and dried under vacuum, yielding a white crystalline solid, identified as the TBD-HBPh4 photo base generator. Following the synthesis of photo base generator, the thiol-acrylate photo-resin are prepared with a 1:1 stoichiometric ratio between thiol [SH] and acrylate [C═C] functional groups. Typically, the photo-resin formulation included approximately 5 g of Thioplast G4, which corresponds to about 5.1 mmol, containing roughly 10.2 mmol of [SH] groups and around 25.5 mmol of disulfide [S—S] bonds. Additionally, around 1.3 g of triacrylate monomers, equivalent to about 3.4 mmol and 10.2 mmol of [C═C] groups, are used. This monomer mixture is then combined with 0.25 wt % Eosin Y, 1 wt % TBD-HBPh4, 3 wt % Omnirad 2100, and 3 wt % TEMPO, with all these weight percentages relative to the total weight of Thioplast G4 and triacrylate. Excess acetone is added to ensure a homogeneous solution, which is subsequently extracted using rotary evaporation and vacuum drying at room temperature. The final photo-resin appeared homogeneous and red in color.

As shown in acrylate and epoxy solution, Omnirad 2100 and HNu470 show totally different absorbance spectra which meet the basic standards for multi-material printing solutions (as shown in FIGS. 23a and 23b). And on the basis of the spectrum, 535 nm green light is used to initiate the photopolymerization of epoxy which glassy hard part and 405 nm UV light is used to initiate the acrylate curing which is elastic. As for thiol-acrylate photo-resin, the absorbance spectra also show totally different peaks for wavelength absorption. 532 nm and 405 wavelengths are also utilized to accomplish multi-material fabrication. In thiol-acrylate photo-resin, green light produces reversible polymer networks which is used for printing supports and UV light produces permanent polymer network desirable for the primary structure.

To use the epoxy and acrylate mixture as the printing resin, the curing characteristics has to be evaluated for the multi-material LIDG process. Different wavelengths and gray scale levels are used to establish the printing speed of acylate and epoxy curing (as shown in FIG. 23a). It is clear that the curing speed of acrylate is faster than epoxy even using a 3:1 ratio of Acrylate:Epoxy. In order to accomplish simultaneous curing of acrylate and epoxy, different gray scale levels have to be used for green light and UV light.

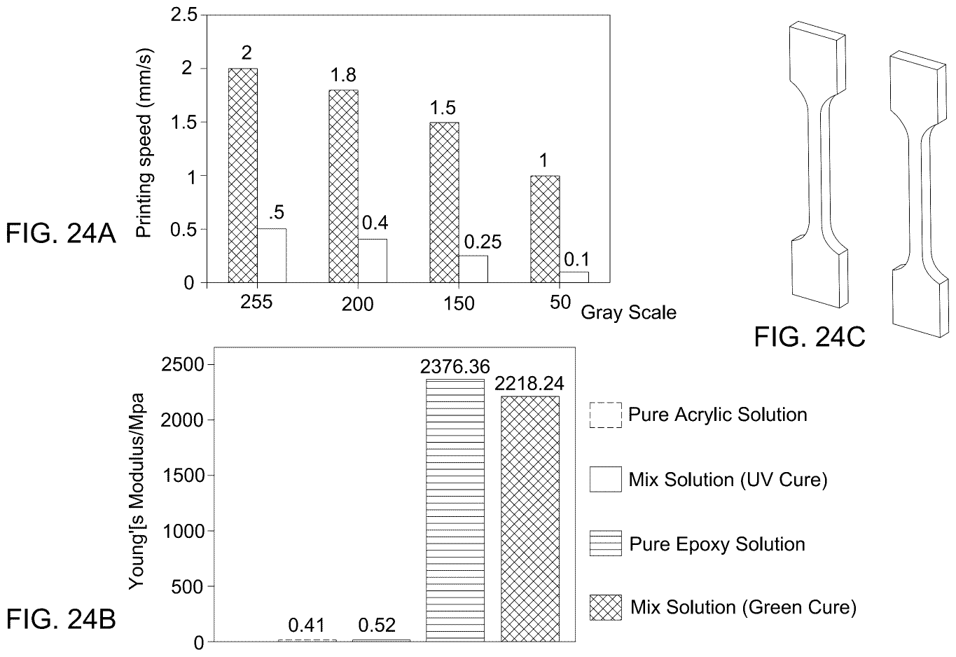

After the study of curing characteristics of epoxy and acrylate, the mechanical properties of both materials are evaluated. Same dog bone structures are printed for tensile test (as shown in FIG. 23c). As discussed previously, all printed dog bones need to be extensively post cured using high power lamp, but the post treatment using light is not enough for multi-material LIDG printing. Specifically, it is not enough for epoxy because the photopolymerization of epoxy is cationic photopolymerization which is slow at room temperature. However, heat significantly increases the reaction rate of cationic photopolymerization. Therefore, all printed structural components are post heated at 70° C. for more than one hour. After post annealing treatment, the cross-link ratios of epoxy structures are clearly increased, which leads to significant increases in mechanical property. As shown in FIG. 24b, the epoxy components exhibit more than 4000 times stronger than acrylate components. Additionally, acrylate cured in mixed solution performs larger Young's modulus than it cured in pure acrylate solution, but epoxy cured in mixed solution is weaker than it cured in pure epoxy solution. It happens because part of one type of monomer is trapped within the network of polymer while the photopolymerization of another monomer is initiated in the acrylate and epoxy mixture. To be specific, epoxy monomer is trapped within the network of acrylate increasing the mechanical property. Similarly, acrylic monomer is also trapped within the network of epoxy but acrylic monomer diminishes the mechanical property.

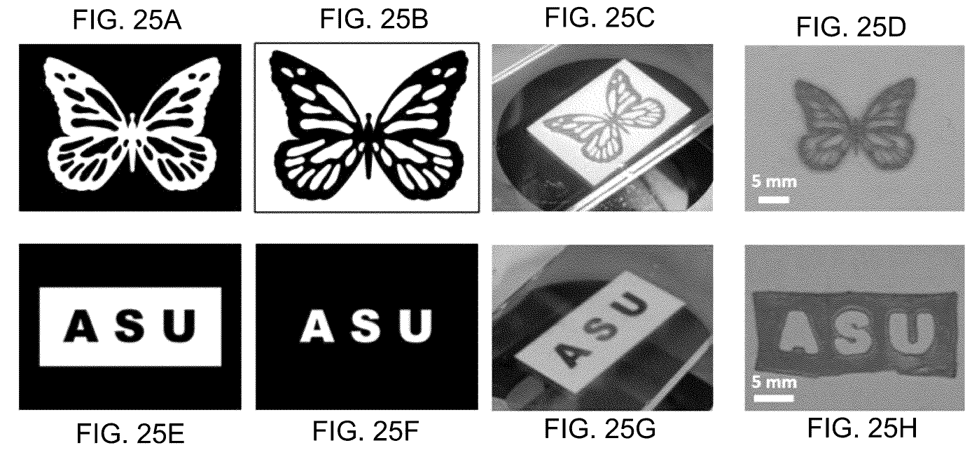

Even though curing characteristic study is important for 3D printing process, thiol-acrylate photo-resin is extremely hard to be cured and the curing height is too limited to do curing characteristics study. Therefore, demo printing is directly conducted for this formulation (as shown in FIG. 25). As mentioned above, the thiol-acrylate photo-resins can be selectively cured by green light or UV light to form a degradable, dynamic network or a non-degradable, permanent network, respectively. This unique capability of undergoing orthogonal wavelength-selective reactions makes the thiol-acrylate photo-resin suitable for fabricating crosslinked multi-materials with programmed degradability. For demonstration, the photo-resin is cast between two glass slides with approximately 0.5-mm-thick spacers, and the assembly is irradiated with patterned UV light through a photomask featuring an “ASU” logo or a “butterfly” shape. After patterned UV curing, the entire film (comprising both UV-cured and uncured regions) is irradiated with green light. The resulting single-layer films appeared visually featureless, with no apparent interface between the green- and UV-light cured regions. After selectively degrading the green-light irradiated regions in these single-layer films, discrete holes are created within the continuous UV-light irradiated pattern, thus revealing the originally hidden “ASU” logo and the “butterfly” shape. Notably, the new surfaces formed after removing the green-light irradiated regions also appeared relatively smooth. These results demonstrate that the thiol-acrylate photo-resins can undergo orthogonal wavelength-selective reactions under patterned green- and UV-light irradiation to form crosslinked multi-materials with pre-designed degradable regions, which can be subsequently removed to reveal the underlying photomask patterns.

Here, a multiwavelength assisted LIDG process is developed which is capable of multi-material fabrication. Two different formulations are generated for different purposes using the same two wavelengths 532 nm and 405 nm. One formulation is epoxy and acrylate mixture and components with different mechanical properties can be fabricated using two different wavelengths. The mechanical property is demonstrated by tensile test. As for thiol-acrylate photo-resin, green light produces reversible polymer networks which is used for printing supports and UV light produces permanent polymer network desirable for the primary structure. The degradation is demonstrated by the fabrication of butterfly and ASU logo.

Various features and advantages of the invention are set forth in the following claims.

What is claimed is:

1. A method of forming a part within a resin tank of a 3D printer, the method comprising:
curing a bottom surface of the part within a first section of the resin tank via a focused curing light while exposing a remainder of the resin tank to an inhibition light;
curing a middle section of the part within a second section of the resin tank via the curing light while exposing areas above and below the second section to the inhibition light; and
curing a top surface of the part within a third section of the resin tank via the curing light while exposing the remainder of the resin tank to the inhibition light.

2. The method of claim 1, wherein the first section of the resin tank is a bottom section of the resin tank.

3. The method of claim 1, wherein the curing light is shown through a bottom of the resin tank.

4. The method of claim 3, wherein the inhibition light is shown through a sidewall of the resin tank.

5. The method of claim 1, wherein the curing light is shown through a top of the resin tank.

6. The method of claim 1, wherein the curing light is shown through a top and a bottom of the resin tank.

7. The method of claim 1, wherein curing the bottom surface, the middle section, and the top surface of the part includes photopolymerization.

8. The method of claim 1, wherein curing the bottom surface, curing the middle section, and curing the top surface are completed in order and continuously such that no layer or stair-case effect is in the part once the top surface is cured.

9. The method of claim 1, wherein the resin tank is not refilled during the forming of the part.

10. The method of claim 1, wherein the bottom surface, the middle section, and the top surface are cured via a curing light from a projector, wherein the curing light from the projector passes through a convex lens prior to curing the bottom surface, the middle section, and the top surface.

11. The method of claim 10, wherein the resin tank is movable relative to the projector as the bottom surface, the middle section, and the top surface are cured.

12. The method of claim 11, wherein the resin tank is supported by a linear stage, wherein the linear stage moves the resin tank relative to the projector.

13. The method of claim 12, wherein the resin tank moves continuously during the forming of the part.

14. The method of claim 12, wherein the inhibition light is generated by an inhibition projector separate from the projector providing the curing light.

15. The method of claim 14, wherein the inhibition projector is supported by the linear stage and movable with the resin tank.

16. An apparatus for forming a part within a resin tank of a 3D printer, the apparatus comprising:
a resin tank having a bottom surface and a sidewall and configured to hold a resin material;
a projector configured to focus a curing light through the bottom surface of the resin tank to cure a first portion of the resin material; and
an inhibition projector configured to focus an inhibition light through the sidewall of the resin tank to inhibit curing of a second portion of the resin material.

17. The apparatus of claim 16, wherein the projector is configured to cure the first portion of the resin material via continuous photopolymerization such that no layer or stair-case effect is in the part.

18. The apparatus of claim 16, further comprising a convex lens, wherein the curing light from the projector passes through the convex lens prior to curing the first portion of the resin material.

19. The apparatus of claim 16, further comprising a linear stage coupled to the resin tank and configured to move the resin tank relative to the projector during formation of the part.

20. The apparatus of claim 19, wherein the inhibition projector is supported by the linear stage and movable with the resin tank relative to the projector.
